(19) United States
(12) Patent Application Publication
(10) Pub. No.: US 2023/0358888 A1
(43) Pub. Date: Nov. 9, 2023

(54) SYSTEMS AND METHODS FOR DETECTING FLOOR FROM NOISY DEPTH MEASUREMENTS FOR ROBOTS

(71) Applicant: Brain Corporation, San Diego, CA (US)

(72) Inventors: Ryan Lustig, San Diego, CA (US); Cristian Troncoso, San Diego, CA (US)

(21) Appl. No.: 18/205,669

(22) Filed: Jun. 5, 2023

Related U.S. Application Data
(63) Continuation of application No. PCT/US21/63484, filed on Dec. 15, 2021.
(60) Provisional application No. 63/127,611, filed on Dec. 18, 2020.

(51) Int. Cl. G01S 17/89; G06T 1/00; G01S 17/931

(52) U.S. Cl. CPC G01S 17/89; G06T 1/0014; G01S 17/931

(57) ABSTRACT

Systems and methods for detecting floor from noisy depth measurements for robots are disclosed herein. According to at least one non-limiting exemplary embodiment, a height map may be produced based on one or more depth measurements from a sensor of a robot. The height map may be utilized to determine surface normal vectors which may be further utilized by the robot to determine if regions of the height map are floor.

### PRIORITY

This application is a continuation of International Patent Application No. PCT/US21/63484 filed Dec. 15, 2021 and claims the benefit of U.S. Provisional Patent Application Ser. No. 63/127,611 filed on Dec. 18, 2020 under 35 U.S.C. § 119, the entire disclosure of which is incorporated herein by reference.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

### Technological Field

The present application relates generally to robotics and, more specifically, to systems and methods for detecting floor from noisy depth measurements for robots.

### SUMMARY

The needs and deficiencies in the conventional technology are satisfied by the present disclosure, which provides for, inter alia, systems and methods for detecting floor from noisy depth measurements for robots.

Exemplary embodiments described herein have innovative features, no single one of which is indispensable or solely responsible for their desirable attributes. Without limiting the scope of the claims, some of the advantageous features will now be summarized. One skilled in the art would appreciate that, as used herein, the term robot may generally refer to an autonomous vehicle or object that travels a route, executes a task, or otherwise moves automatically upon executing or processing computer readable instructions.

According to at least one non-limiting exemplary embodiment, a robotic system is disclosed. The robotic system, comprises: at least one sensor configured to generate a plurality of points corresponding to distance measurements; a non-transitory computer readable storage medium comprising a plurality of computer readable instructions stored thereon; and at least one controller configured to execute the computer readable instructions to: receive a set of points from a scan by the at least one sensor; project the set of points onto a two-dimensional height map, the height map comprises a plurality of pixels, each pixel being encoded with a height value based on height values of the points projected thereon; calculate a surface normal unit vector for the each pixel of the height map based on the height values; and determine one or more pixels of the height map corresponding to a floor space based on a respective surface normal unit vector being within a threshold deviation from a reference surface normal unit vector.

According to at least one non-limiting exemplary embodiment the at least one controller to is further configured to execute the computer readable instructions to: determine a first component of the respective surface normal unit vector for each pixel of the height map based on height value differences between a first pixel and a second pixel, the second pixel being adjacent to the first pixel along a first axis; determine a second component of the respective surface normal unit vector based on height value differences between the first pixel and a third pixel, the third pixel being adjacent to the first pixel along a second axis orthogonal to the first axis; and calculate the respective surface normal unit vector based on the cross product of the first and second components.

According to at least one non-limiting exemplary embodiment, the at least one controller to is further configured to execute the computer readable instructions to: determine a third component of the respective surface normal unit vector for each pixel of the height map based on height value differences between the first pixel and a fourth pixel, the fourth pixel being along the first axis and different from the second pixel; determine a fourth component of the respective surface normal unit vector based on height value differences between the first pixel and a fifth pixel, the fifth pixel being along the second axis orthogonal to the first axis; and calculate the respective surface normal unit vector based on an average of the cross product of the first and second components and the third and fourth components.

According to at least one non-limiting exemplary embodiment the controller utilizes a subset of points from the set of points of the scan which are within a threshold distance from the robot when producing the height map.

According to at least one non-limiting exemplary embodiment the controller utilizes points of the set of points which are within a threshold height above the robot or floor when producing the height map.

According to at least one non-limiting exemplary embodiment the at least one controller to is further configured to execute the computer readable instructions to: produce a floor mask, the floor mask comprises a plurality of pixels identified as corresponding to floor, the pixels being pixels of at least one of: (i) a computer readable map, the computer readable map comprises objects localized thereon; or (ii) pixels of a depth image captured by the at least sensor.

According to at least one non-limiting exemplary embodiment, a robotic system is disclosed. The robotic system, comprises: at least one sensor configured to generate a plurality points corresponding to distance measurements; a non-transitory computer readable storage medium having a plurality of computer readable instructions stored thereon; and at least one controller configured to execute the instructions to: receive a set of points from a scan by the at least one sensor; project the set of points onto a two-dimensional height map, the height map comprises a plurality of pixels, each pixel being encoded with a height value based on height values of the points projected thereon; calculate a respective surface normal unit vector for each pixel of the height map based on the height values by: determining a first component of the respective surface normal unit vector based on height value differences between a first pixel and a second pixel, the second pixel being adjacent to the first pixel along a first axis; determining a second component of the respective surface normal unit vector based on height value differences between the first pixel and a third pixel, the third pixel being adjacent to the first pixel along a second axis orthogonal to the first axis; and calculating the surface normal unit vector based on the cross product of the first and second components; determine one or more pixels of the height map correspond to floor space based on the respective surface normal unit vector of the one or more pixels being within a threshold deviation from an reference surface normal unit vector; and produce a floor mask, the floor mask comprises a plurality of pixels identified as corresponding to floor, the pixels being pixels of at least one of (i) a computer readable map, the computer readable map comprises objects localized thereon; or (ii) pixels of a depth image captured by the at least sensor; wherein, the controller utilizes points of the set of points which are within a threshold distance from the robot when producing the height map; and the controller utilizes points of the set of points which are within a threshold height above the robot or floor when producing the height map.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of “a”, “an”, and “the” include plural referents unless the context clearly dictates otherwise.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1A is a functional block diagram of a robot in accordance with some embodiments of this disclosure.

FIG. 1B is a functional block diagram of a controller or processor in accordance with some embodiments of this disclosure.

FIG. 2A(i)-(ii) illustrates a light detection and ranging (“LiDAR”) sensor and point clouds generated therefrom, according to an exemplary embodiment.

FIG. 2B illustrates three transforms used by a robot to transform measurements from a sensor to various frames of references, according to an exemplary embodiment.

FIG. 2C illustrates a scenario where the location of a floor may be erroneously determined by a LiDAR sensor, according to an exemplary embodiment.

FIG. 3 illustrates an image plane of a LiDAR sensor, according to an exemplary embodiment.

FIG. 4A illustrates a robot comprising a LiDAR sensor, according to an exemplary embodiment.

FIG. 4B illustrates a plurality of points being localized in three-dimensional space and being projected onto a height map, according to an exemplary embodiment.

FIGS. 5A, 5B(i) and 5B(ii) illustrate a method of calculating a surface normal unit vector for pixels of a height map, according to an exemplary embodiment.

FIGS. 6(i)-(ii) illustrate thresholds used to determine if a pixel of a height map corresponds to floor based on its surface normal unit vector, according to an exemplary embodiment.

FIG. 7 is a process flow diagram illustrating a method for a controller of a robot to detect floor based on measurements from LiDAR sensors, according to at least one non-limiting exemplary embodiment.

FIG. 8A-D illustrates methods for identifying floors within a height map, a cost map, and within depth imagery, according to an exemplary embodiment.

FIG. 9 illustrates a histogram of height values used to determine if a flat surface corresponds to floor, according to an exemplary embodiment.

All Figures disclosed herein are © Copyright 2021 Brain Corporation. All rights reserved.

### DETAILED DESCRIPTION

Currently, many robots use depth cameras and/or scanning light detection and ranging (“LiDAR”) sensors to navigate within their environments. These robots, in executing their programmed operations, may often encounter tight turns, narrow passageways, and/or other complex scenarios requiring the robots to detect navigable space around them quickly and accurately. Robots which navigate upon floors may be required to detect navigable floor space surrounding the robots in order to plan their motions accordingly. A simple solution may include determining that all measurements from a LiDAR sensor which are approximately at the z=0 floor plane, with some deviation for noise, correspond to the floor. In some instances, however, poor calibration and/or noise (e.g., from reflective floors beneath bright overhead lights or measurements near the maximum range of the sensor from the sensors) may cause a floor surrounding a robot to be sensed as rising or at a nonzero height, which may cause the robot to erroneously perceive that objects are present when no objects are present, thereby causing the robot to stop for no apparent reason.

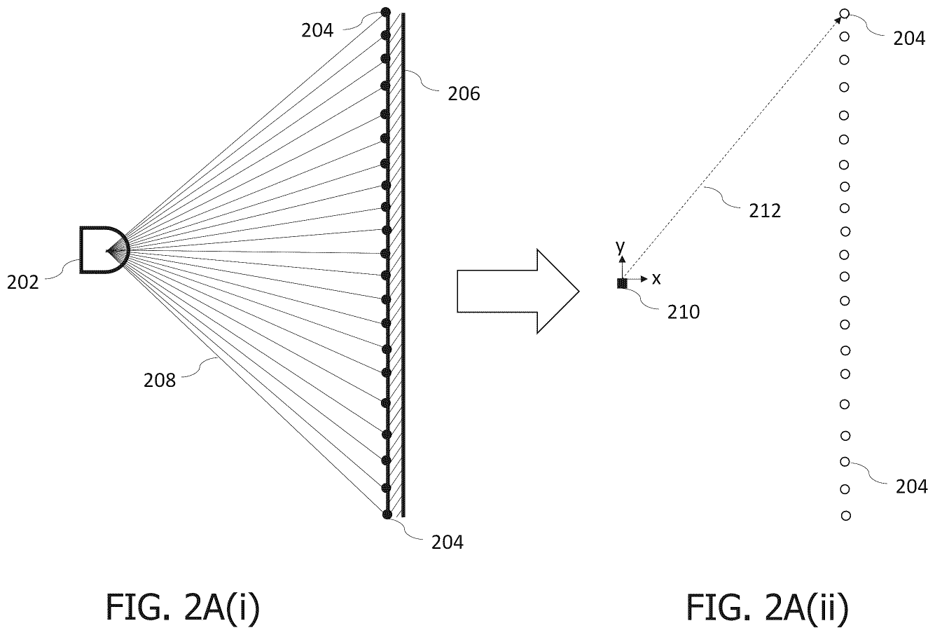

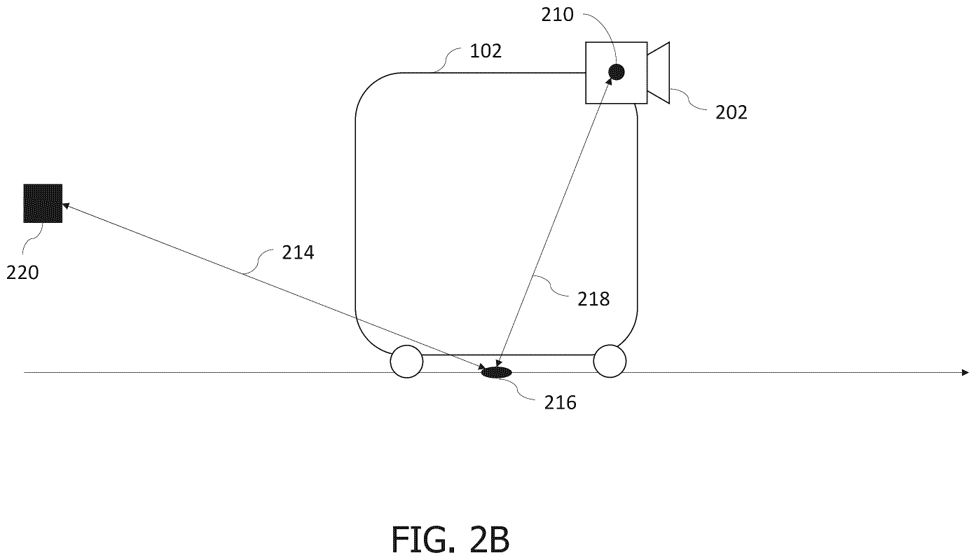

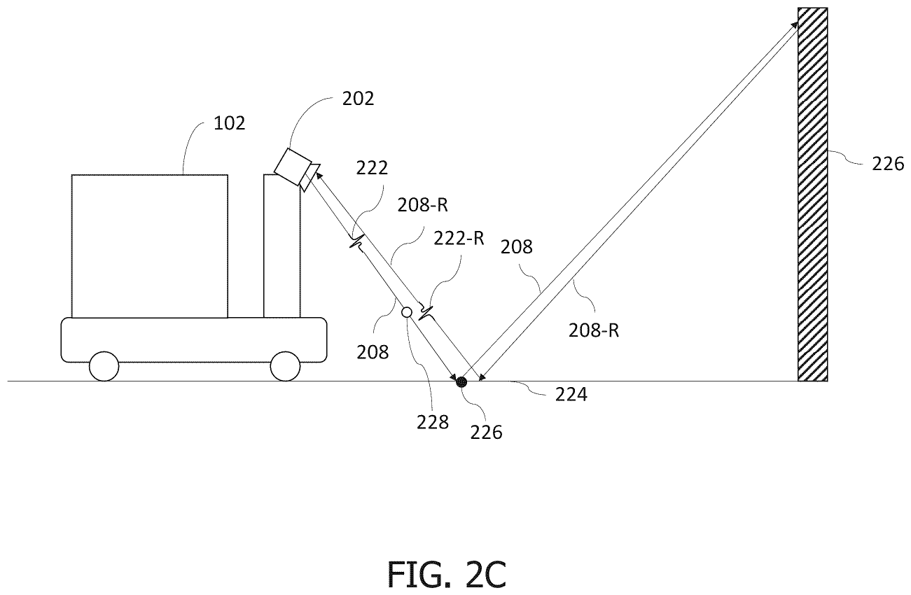

Some LiDAR sensors may utilize periodic signals and phase differences between an emitted signal and a returning signal to calculate time of flight, and thereby distance. In some instances, periodic signals or pulses emitted from LiDAR sensors may experience wraparound effects due to reflectivity of shiny floors, wherein the returned signal includes more than a 2π phase difference from the emitted signal. For example, a returning or reflected signal from a LiDAR sensor may include a 2π+N phase difference, which may cause some LiDAR sensors to associate the phase difference as N rather than 2π+N, which may cause an underestimation of a time of flight of an emitted signal, thereby causing objects (and floor) to be perceived as substantially closer to the LiDAR sensor (as further illustrated in FIG. 2C below). In some instances, detecting floor surrounding the robot may be useful for motion planning by enabling the robots to determine routes to navigate based on detection of available floor. Accordingly, there is a need in the art for systems and methods for detecting flat floor surrounding a robot, which accounts for various errors in localization by LiDAR sensors.

In some embodiments, distance measuring LiDAR sensors may utilize periodic signals and a measured phase difference to determine time of flight (“ToF”) to calculate distance. Use of periodic signals may be advantageous in reducing hardware complexity of ToF devices; however, some drawbacks are realized. In some scenarios, where depth of scene changes rapidly and surfaces of objects are highly reflective, floor space near the camera may appear to rise or deviate from an expected height. In some cases, periodic signals may cause wrap-around effects, causing objects that are a far distance from the sensor to be localized at a very short distance from the sensor. Accordingly, depth values alone may not be sufficient to detect floor space surrounding a robot, wherein the systems and methods of the present disclosure are directed towards solving these deficiencies.

Various aspects of the novel systems, apparatuses, and methods disclosed herein are described more fully hereinafter with reference to the accompanying drawings. This disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art would appreciate that the scope of the disclosure is intended to cover any aspect of the novel systems, apparatuses, and methods disclosed herein, whether implemented independently of, or combined with, any other aspect of the disclosure. For example, an apparatus may be implemented or a method may be practiced using any number of the aspects set forth herein. In addition, the scope of the disclosure is intended to cover such an apparatus or method that is practiced using other structure, functionality, or structure and functionality in addition to or other than the various aspects of the disclosure set forth herein. It should be understood that any aspect disclosed herein may be implemented by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, and/or objectives. The detailed description and drawings are merely illustrative of the disclosure, rather than limiting the scope of the disclosure, being defined by the appended claims and equivalents thereof.

The present disclosure provides for systems and methods for detecting floor from noisy depth measurements for robots. As used herein, a robot may include mechanical and/or virtual entities configured to carry out a complex series of tasks or actions autonomously. In some exemplary embodiments, robots may be machines that are guided and/or instructed by computer programs and/or electronic circuitry. In some exemplary embodiments, robots may include electro-mechanical components that are configured for navigation, where the robot may move from one location to another. Such robots may include autonomous and/or semi-autonomous cars, floor cleaners, rovers, drones, planes, boats, carts, trams, wheelchairs, industrial equipment, stocking machines, mobile platforms, personal transportation devices (e.g., hover boards, scooters, self-balancing vehicles, such as manufactured by Segway, etc.), trailer movers, vehicles, and the like. Robots may also include any autonomous and/or semi-autonomous machine for transporting items, people, animals, cargo, freight, objects, luggage, and/or anything desirable from one location to another.

As used herein, a floor may include any substantially flat and level (horizontal) surface. Level surface, as used in the definition, may correspond to any surface or plane comprising a unit vector that is substantially parallel to the force of gravity and/or does not include flat vertical surfaces, such as walls, or sloped ramps.

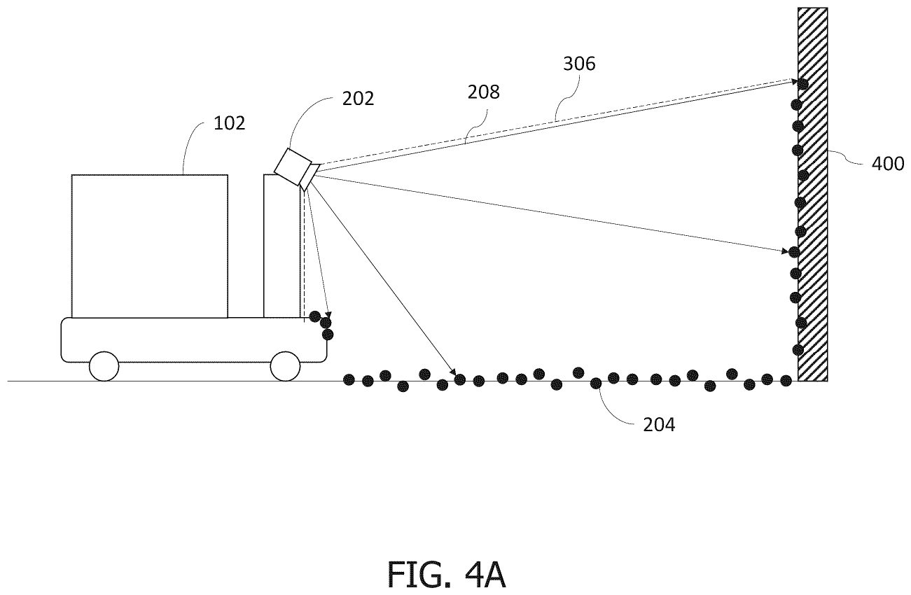

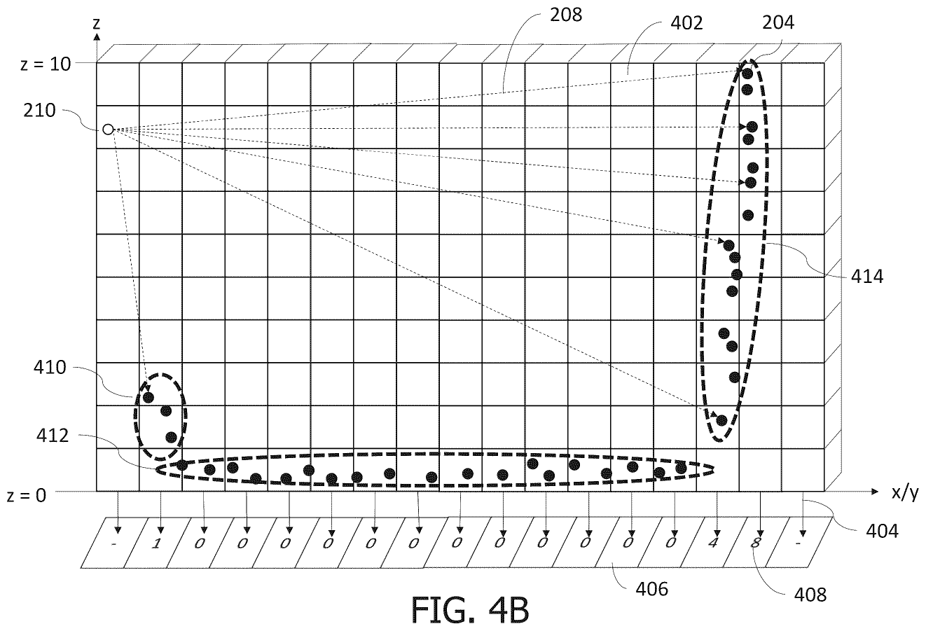

A Cartesian coordinate system is disclosed herein. For clarity of illustration, the Cartesian coordinate system described with respect to FIGS. 4-7 remains the same. The coordinate system may comprise an x-y plane corresponding roughly to an expected height of a floor. That is, z=0 plane corresponds to an expected floor height. The z-axis points directly upwards from the floor (i.e., opposite the direction of gravity). For example, a sensor positioned 1 meter above a floor would expect to localize the floor at z=0 exactly 1 meter directly below the sensor. In practice, measurements of a floor from sensors may not always yield exactly z=0 measurements due to noise and/or calibration errors. The systems and methods of this disclosure enable robots to detect floor even if the measurements do not exactly localize the floor along the z=0 plane. One skilled in the art given the contents of this disclosure may appreciate that the Cartesian coordinate system used herein is purely exemplary and may be replaced by other coordinate systems defined about different origins.

As used herein, network interfaces may include any signal, data, or software interface with a component, network, or process, including, without limitation, those of the FireWire (e.g., FW400, FW800, FWS800T, FWS1600, FWS3200, etc.), universal serial bus (“USB”) (e.g., USB 1.X, USB 2.0, USB 3.0, USB Type-C, etc.), Ethernet (e.g., 10/100, 10/100/1000 (Gigabit Ethernet), 10-Gig-E, etc.), multimedia over coax alliance technology (“MoCA”), Coaxsys (e.g., TVNET™), radio frequency tuner (e.g., in-band or OOB, cable modem, etc.), Wi-Fi (802.11), WiMAX (e.g., WiMAX (802.16)), PAN (e.g., PAN/802.15), cellular (e.g., 3G, 4G, 5G, LTE/LTE-A/TD-LTE/TD-LTE, GSM, etc.), IrDA families, etc. As used herein, Wi-Fi may include one or more of IEEE-Std. 802.11, variants of IEEE-Std. 802.11, standards related to IEEE-Std. 802.11 (e.g., 802.11 a/b/g/n/ac/ad/af/ah/ai/aj/aq/ax/ay), and/or other wireless standards.

As used herein, processor, microprocessor, and/or digital processor may include any type of digital processor, such as, without limitation, digital signal processors (“DSPs”), reduced instruction set computers (“RISC”), complex instruction set computers (“CISC”) processors, microprocessors, gate arrays (e.g., field programmable gate arrays (“FPGAs”)), programmable logic device (“PLDs”), reconfigurable computer fabrics (“RCFs”), array processors, secure microprocessors, and application-specific integrated circuits (“ASICs”). Such digital processors may be contained on a single unitary integrated circuit die or distributed across multiple components.

As used herein, computer program and/or software may include any sequence or human or machine cognizable steps that perform a function. Such computer program and/or software may be rendered in any programming language or environment, including, for example, C/C++, C #, Fortran, COBOL, MATLAB™, PASCAL, GO, RUST, SCALA, Python, assembly language, markup languages (e.g., HTML, SGML, XML, VoXML), and the like, as well as object-oriented environments, such as the Common Object Request Broker Architecture (“CORBA”), JAVA™ (including J2ME, Java Beans, etc.), Binary Runtime Environment (e.g., “BREW”), and the like.

As used herein, connection, link, and/or wireless link may include a causal link between any two or more entities (whether physical or logical/virtual), which enables information exchange between the entities.

As used herein, computer and/or computing device may include, but are not limited to, personal computers (“PCs”) and minicomputers, whether desktop, laptop, or otherwise, mainframe computers, workstations, servers, personal digital assistants (“PDAs”), handheld computers, embedded computers, programmable logic devices, personal communicators, tablet computers, mobile devices, portable navigation aids, J2ME equipped devices, cellular telephones, smart phones, personal integrated communication or entertainment devices, and/or any other device capable of executing a set of instructions and processing an incoming data signal.

Detailed descriptions of the various embodiments of the system and methods of the disclosure are now provided. While many examples discussed herein may refer to specific exemplary embodiments, it will be appreciated that the described systems and methods contained herein are applicable to any kind of robot. Myriad other embodiments or uses for the technology described herein would be readily envisaged by those having ordinary skill in the art, given the contents of the present disclosure.

Advantageously, the systems and methods of this disclosure at least: (i) enable robots to remove noisy measurements from LiDAR sensors; (ii) improve robot navigation and perception by enhancing the ability of robots to identify navigable space surrounding them; and (iii) improve performance of robots by enabling robots to detect floor separate from other objects, even if the floor is improperly localized due to poor calibration, biases, and/or noise. Other advantages are readily discernable by one having ordinary skill in the art given the contents of the present disclosure.

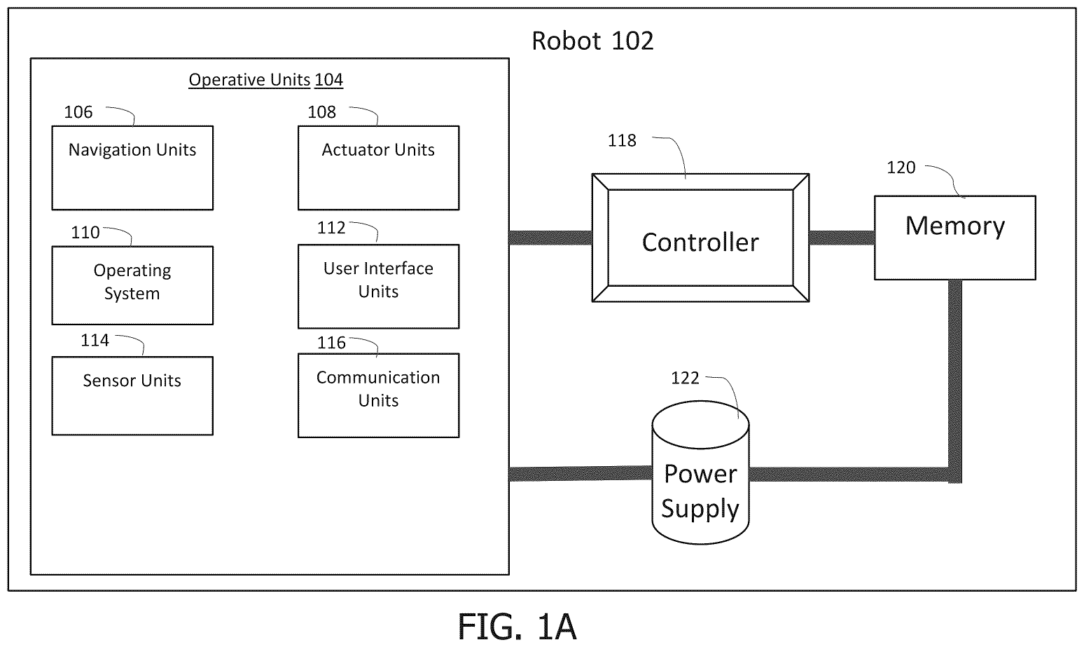

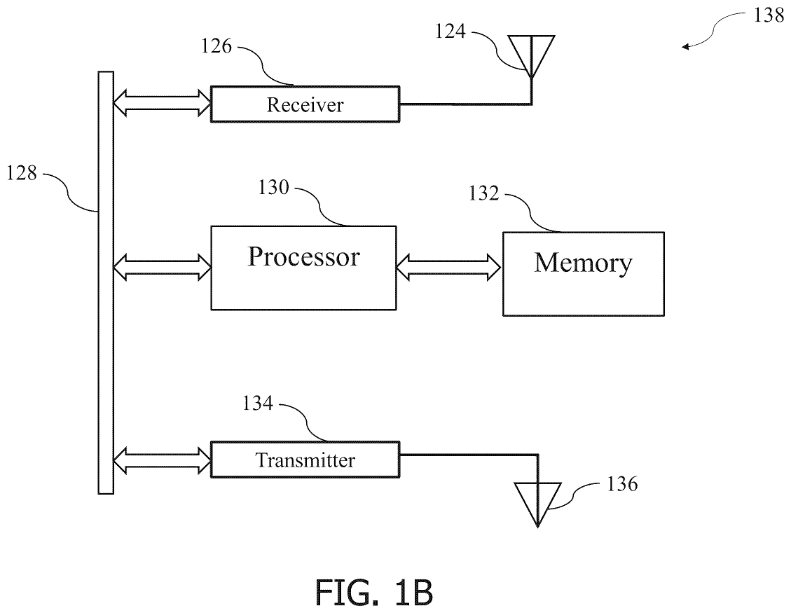

FIG. 1A is a functional block diagram of a robot 102 in accordance with some principles of this disclosure. As illustrated in FIG. 1A, robot 102 may include controller 118, memory 120, user interface unit 112, sensor units 114, navigation units 106, actuator unit 108, and communications unit 116, as well as other components and subcomponents (e.g., some of which may not be illustrated). Although a specific embodiment is illustrated in FIG. 1A, it is appreciated that the architecture may be varied in certain embodiments as would be readily apparent to one of ordinary skill given the contents of the present disclosure. As used herein, robot 102 may be representative at least in part of any robot described in this disclosure.

Controller 118 may control the various operations performed by robot 102. Controller 118 may include and/or comprise one or more processors (e.g., microprocessors) and other peripherals. As previously mentioned and used herein, processor, microprocessor, and/or digital processor may include any type of digital processor, such as, without limitation, digital signal processors (“DSPs”), reduced instruction set computers (“RISC”), complex instruction set computers (“CISC”), microprocessors, gate arrays (e.g., field programmable gate arrays (“FPGAs”)), programmable logic device (“PLDs”), reconfigurable computer fabrics (“RCFs”), array processors, secure microprocessors, and application-specific integrated circuits (“ASICs”). Peripherals may include hardware accelerators configured to perform a specific function using hardware elements, such as, without limitation, encryption/description hardware, algebraic processors (e.g., tensor processing units, quadratic problem solvers, multipliers, etc.), data compressors, encoders, arithmetic logic units (“ALU”), and the like. Such digital processors may be contained on a single unitary integrated circuit die or distributed across multiple components.

Controller 118 may be operatively and/or communicatively coupled to memory 120. Memory 120 may include any type of integrated circuit or other storage device configured to store digital data, including, without limitation, read-only memory (“ROM”), random access memory (“RAM”), non-volatile random access memory (“NVRAM”), programmable read-only memory (“PROM”), electrically erasable programmable read-only memory (“EEPROM”), dynamic random-access memory (“DRAM”), Mobile DRAM, synchronous DRAM (“SDRAM”), double data rate SDRAM (“DDR/2 SDRAM”), extended data output (“EDO”) RAM, fast page mode RAM (“FPM”), reduced latency DRAM (“RLDRAM”), static RAM (“SRAM”), flash memory (e.g., NAND/NOR), memristor memory, pseudostatic RAM (“PSRAM”), etc. Memory 120 may provide instructions and data to controller 118. For example, memory 120 may be a non-transitory, computer-readable storage apparatus and/or medium having a plurality of instructions stored thereon, the instructions being executable by a processing apparatus (e.g., controller 118) to operate robot 102. In some cases, the instructions may be configured to, when executed by the processing apparatus, cause the processing apparatus to perform the various methods, features, and/or functionality described in this disclosure. Accordingly, controller 118 may perform logical and/or arithmetic operations based on program instructions stored within memory 120. In some cases, the instructions and/or data of memory 120 may be stored in a combination of hardware, some located locally within robot 102, and some located remote from robot 102 (e.g., in a cloud, server, network, etc.).

It should be readily apparent to one of ordinary skill in the art that a processor may be internal to or on board robot 102 and/or may be external to robot 102 and be communicatively coupled to controller 118 of robot 102 utilizing communication units 116 wherein the external processor may receive data from robot 102, process the data, and transmit computer-readable instructions back to controller 118. In at least one non-limiting exemplary embodiment, the processor may be on a remote server (not shown).

In some exemplary embodiments, memory 120, shown in FIG. 1A, may store a library of sensor data. In some cases, the sensor data may be associated at least in part with objects and/or people. In exemplary embodiments, this library may include sensor data related to objects and/or people in different conditions, such as sensor data related to objects and/or people with different compositions (e.g., materials, reflective properties, molecular makeup, etc.), different lighting conditions, angles, sizes, distances, clarity (e.g., blurred, obstructed/occluded, partially off frame, etc.), colors, surroundings, and/or other conditions. The sensor data in the library may be taken by a sensor (e.g., a sensor of sensor units 114 or any other sensor) and/or generated automatically, such as with a computer program that is configured to generate/simulate (e.g., in a virtual world) library sensor data (e.g., which may generate/simulate these library data entirely digitally and/or beginning from actual sensor data) from different lighting conditions, angles, sizes, distances, clarity (e.g., blurred, obstructed/occluded, partially off frame, etc.), colors, surroundings, and/or other conditions. The number of images in the library may depend at least in part on one or more of the amount of available data, the variability of the surrounding environment in which robot 102 operates, the complexity of objects and/or people, the variability in appearance of objects, physical properties of robots, the characteristics of the sensors, and/or the amount of available storage space (e.g., in the library, memory 120, and/or local or remote storage). In exemplary embodiments, at least a portion of the library may be stored on a network (e.g., cloud, server, distributed network, etc.) and/or may not be stored completely within memory 120. As yet another exemplary embodiment, various robots (e.g., that are commonly associated, such as robots by a common manufacturer, user, network, etc.) may be networked so that data captured by individual robots are collectively shared with other robots. In such a fashion, these robots may be configured to learn and/or share sensor data in order to facilitate the ability to readily detect and/or identify errors and/or assist events.

Still referring to FIG. 1A, operative units 104 may be coupled to controller 118, or any other controller, to perform the various operations described in this disclosure. One, more, or none of the modules in operative units 104 may be included in some embodiments. Throughout this disclosure, reference may be to various controllers and/or processors. In some embodiments, a single controller (e.g., controller 118) may serve as the various controllers and/or processors described. In other embodiments, different controllers and/or processors may be used, such as controllers and/or processors used particularly for one or more operative units 104. Controller 118 may send and/or receive signals, such as power signals, status signals, data signals, electrical signals, and/or any other desirable signals, including discrete and analog signals to operative units 104. Controller 118 may coordinate and/or manage operative units 104, and/or set timings (e.g., synchronously or asynchronously), turn off/on control power budgets, receive/send network instructions and/or updates, update firmware, send interrogatory signals, receive and/or send statuses, and/or perform any operations for running features of robot 102.

Returning to FIG. 1A, operative units 104 may include various units that perform functions for robot 102. For example, operative units 104 include at least navigation units 106, actuator units 108, user interface units 112, sensor units 114, and communication units 116. Operative units 104 may also comprise other units, such as specifically configured task units (not shown), that provide the various functionality of robot 102. In exemplary embodiments, operative units 104 may be instantiated in software, hardware, or both software and hardware. For example, in some cases, units of operative units 104 may comprise computer-implemented instructions executed by a controller. In exemplary embodiments, units of operative unit 104 may comprise hardcoded logic (e.g., ASICS). In exemplary embodiments, units of operative units 104 may comprise both computer-implemented instructions executed by a controller and hardcoded logic. Where operative units 104 are implemented in part in software, operative units 104 may include units/modules of code configured to provide one or more functionalities.

In exemplary embodiments, navigation units 106 may include systems and methods that may computationally construct and update a map of an environment, localize robot 102 (e.g., find its position) in a map, and navigate robot 102 to/from destinations. The mapping may be performed by imposing data obtained in part by sensor units 114 into a computer-readable map representative at least in part of the environment. In exemplary embodiments, a map of an environment may be uploaded to robot 102 through user interface units 112, uploaded wirelessly or through wired connection, or taught to robot 102 by a user.

In exemplary embodiments, navigation units 106 may include components and/or software configured to provide directional instructions for robot 102 to navigate. Navigation units 106 may process maps, routes, and localization information generated by mapping and localization units, data from sensor units 114, and/or other operative units 104.

Still referring to FIG. 1A, actuator units 108 may include actuators, such as electric motors, gas motors, driven magnet systems, solenoid/ratchet systems, piezoelectric systems (e.g., inchworm motors), magnetostrictive elements, gesticulation, and/or any way of driving an actuator known in the art. By way of illustration, such actuators may actuate the wheels for robot 102 to navigate a route; navigate around obstacles; or repose cameras and sensors. According to exemplary embodiments, actuator unit 108 may include systems that allow movement of robot 102, such as motorize propulsion. For example, motorized propulsion may move robot 102 in a forward or backward direction, and/or be used at least in part in turning robot 102 (e.g., left, right, and/or any other direction). By way of illustration, actuator unit 108 may control if robot 102 is moving or is stopped and/or allow robot 102 to navigate from one location to another location.

Actuator unit 108 may also include any system used for actuating and, in some cases actuating task units to perform tasks. For example, actuator unit 108 may include driven magnet systems, motors/engines (e.g., electric motors, combustion engines, steam engines, and/or any type of motor/engine known in the art), solenoid/ratchet system, piezoelectric system (e.g., an inchworm motor), magnetostrictive elements, gesticulation, and/or any actuator known in the art.

According to exemplary embodiments, sensor units 114 may comprise systems and/or methods that may detect characteristics within and/or around robot 102. Sensor units 114 may comprise a plurality and/or a combination of sensors. Sensor units 114 may include sensors that are internal to robot 102 or external, and/or have components that are partially internal and/or partially external. In some cases, sensor units 114 may include one or more exteroceptive sensors, such as sonars, light detection and ranging (“LiDAR”) sensors, radars, lasers, cameras (including video cameras (e.g., red-blue-green (“RBG”) cameras, infrared cameras, three-dimensional (“3D”) cameras, thermal cameras, etc.), time of flight (“ToF”) cameras, structured light cameras, etc.), antennas, motion detectors, microphones, and/or any other sensor known in the art. According to some exemplary embodiments, sensor units 114 may collect raw measurements (e.g., currents, voltages, resistances, gate logic, etc.) and/or transformed measurements (e.g., distances, angles, detected points in obstacles, etc.). In some cases, measurements may be aggregated and/or summarized. Sensor units 114 may generate data based at least in part on distance or height measurements. Such data may be stored in data structures, such as matrices, arrays, queues, lists, arrays, stacks, bags, etc.

According to exemplary embodiments, sensor units 114 may include sensors that may measure internal characteristics of robot 102. For example, sensor units 114 may measure temperature, power levels, statuses, and/or any characteristic of robot 102. In some cases, sensor units 114 may be configured to determine the odometry of robot 102. For example, sensor units 114 may include proprioceptive sensors, which may comprise sensors, such as accelerometers, inertial measurement units (“IMU”), odometers, gyroscopes, speedometers, cameras (e.g. using visual odometry), clock/timer, and the like. Odometry may facilitate autonomous navigation and/or autonomous actions of robot 102. This odometry may include robot 102's position (e.g., where position may include robot's location, displacement, and/or orientation, and may sometimes be interchangeable with the term pose as used herein) relative to the initial location. Such data may be stored in data structures, such as matrices, arrays, queues, lists, arrays, stacks, bags, etc. According to exemplary embodiments, the data structure of the sensor data may be called an image.

According to exemplary embodiments, sensor units 114 may be at least in part external to the robot 102 and coupled to communications units 116. For example, a security camera within an environment of a robot 102 may provide a controller 118 of the robot 102 with a video feed via wired or wireless communication channel(s). In some instances, sensor units 114 may include sensors configured to detect a presence of an object at a location, such as, for example, without limitation, a pressure or motion sensor may be disposed at a shopping cart storage location of a grocery store, wherein the controller 118 of the robot 102 may utilize data from the pressure or motion sensor to determine if the robot 102 should retrieve more shopping carts for customers.

According to exemplary embodiments, user interface units 112 may be configured to enable a user to interact with robot 102. For example, user interface units 112 may include touch panels, buttons, keypads/keyboards, ports (e.g., universal serial bus (“USB”), digital visual interface (“DVI”), Display Port, E-Sata, Firewire, PS/2, Serial, VGA, SCSI, audioport, high-definition multimedia interface (“HDMI”), personal computer memory card international association (“PCMCIA”) ports, memory card ports (e.g., secure digital (“SD”) and miniSD), and/or ports for computer-readable medium), mice, rollerballs, consoles, vibrators, audio transducers, and/or any interface for a user to input and/or receive data and/or commands, whether coupled wirelessly or through wires. Users may interact through voice commands or gestures. User interface units 218 may include a display, such as, without limitation, liquid crystal display (“LCDs”), light-emitting diode (“LED”) displays, LED LCD displays, in-plane-switching (“IPS”) displays, cathode ray tubes, plasma displays, high definition (“HD”) panels, 4K displays, retina displays, organic LED displays, touchscreens, surfaces, canvases, and/or any displays, televisions, monitors, panels, and/or devices known in the art for visual presentation. According to exemplary embodiments, user interface units 112 may be positioned on the body of robot 102. According to exemplary embodiments, user interface units 112 may be positioned away from the body of robot 102 but may be communicatively coupled to robot 102 (e.g., via communication units, including transmitters, receivers, and/or transceivers) directly or indirectly (e.g., through a network, server, and/or a cloud). According to exemplary embodiments, user interface units 112 may include one or more projections of images on a surface (e.g., the floor) proximally located to the robot, e.g., to provide information to the occupant or to people around the robot. The information could be the direction of future movement of the robot, such as an indication of moving forward, left, right, back, at an angle, and/or any other direction. In some cases, such information may utilize arrows, colors, symbols, etc.

According to exemplary embodiments, communications unit 116 may include one or more receivers, transmitters, and/or transceivers. Communications unit 116 may be configured to send/receive a transmission protocol, such as BLUETOOTH®, ZIGBEE®, Wi-Fi, induction wireless data transmission, radio frequencies, radio transmission, radio-frequency identification (“RFID”), near-field communication (“NFC”), infrared, network interfaces, cellular technologies, such as 3G (3GPP/3GPP2, CDMA2000, cdmaOne (IS-95), etc.), 4G (LTE, IMT-A, etc.), 5G, high-speed downlink packet access (“HSDPA”), high-speed uplink packet access (“HSUPA”), time division multiple access (“TDMA”), code division multiple access (“CDMA”) (e.g., IS-95A, wideband code division multiple access (“WCDMA”), etc.), frequency hopping spread spectrum (“FHSS”), direct sequence spread spectrum (“DSSS”), global system for mobile communication (“GSM”), Personal Area Network (“PAN”) (e.g., PAN/802.15), worldwide interoperability for microwave access (“WiMAX”), 802.20, long term evolution (“LTE”) (e.g., LTE/LTE-A), time division LTE (“TD-LTE”), global system for mobile communication (“GSM”), narrowband/frequency-division multiple access (“FDMA”), orthogonal frequency-division multiplexing (“OFDM”), analog cellular, cellular digital packet data (“CDPD”), satellite systems, millimeter wave or microwave systems, acoustic, infrared (e.g., infrared data association (“IrDA”)), and/or any other form of wireless data transmission.

Communications unit 116 may also be configured to send/receive signals utilizing a transmission protocol over wired connections, such as any cable that has a signal line and ground. For example, such cables may include Ethernet cables, coaxial cables, Universal Serial Bus (“USB”), FireWire, and/or any connection known in the art. Such protocols may be used by communications unit 116 to communicate to external systems, such as computers, smart phones, tablets, data capture systems, mobile telecommunications networks, clouds, servers, or the like. Communications unit 116 may be configured to send and receive signals comprising numbers, letters, alphanumeric characters, and/or symbols. In some cases, signals may be encrypted, using algorithms such as 128-bit or 256-bit keys and/or other encryption algorithms complying with standards like the Advanced Encryption Standard (“AES”), RSA, Data Encryption Standard (“DES”), Triple DES, and the like. Communications unit 116 may be configured to send and receive statuses, commands, and other data/information. For example, communications unit 116 may communicate with a user operator to allow the user to control robot 102. Communications unit 116 may communicate with a server/network (e.g., a network) in order to allow robot 102 to send data, statuses, commands, and other communications to the server. The server may also be communicatively coupled to computer(s) and/or device(s) that may be used to monitor and/or control robot 102 remotely. Communications unit 116 may also receive updates (e.g., firmware or data updates), data, statuses, commands, and other communications from a server for robot 102.

In exemplary embodiments, operating system 110 may be configured to manage memory 120, controller 118, power supply 122, modules in operative units 104, and/or any software, hardware, and/or features of robot 102. For example, and without limitation, operating system 110 may include device drivers to manage hardware recourses for robot 102.

In exemplary embodiments, power supply 122 may include one or more batteries, including, without limitation, lithium, lithium ion, nickel-cadmium, nickel-metal hydride, nickel-hydrogen, carbon-zinc, silver-oxide, zinc-carbon, zinc-air, mercury oxide, alkaline, or any other type of battery known in the art. Certain batteries may be rechargeable, such as wirelessly (e.g., by resonant circuit and/or a resonant tank circuit) and/or plugging into an external power source. Power supply 122 may also be any supplier of energy, including wall sockets and electronic devices that convert solar, wind, water, nuclear, hydrogen, gasoline, natural gas, fossil fuels, mechanical energy, steam, and/or any power source into electricity.

One or more of the units described with respect to FIG. 1A (including memory 120, controller 118, sensor units 114, user interface unit 112, actuator unit 108, communications unit 116, mapping and localization unit 126, and/or other units) may be integrated onto robot 102, such as in an integrated system. However, according to some exemplary embodiments, one or more of these units may be part of an attachable module. This module may be attached to an existing apparatus to automate so that it behaves as a robot or increase the capabilities of an existing robot. Accordingly, the features described in this disclosure with reference to robot 102 may be instantiated in a module that may be attached to an existing apparatus and/or integrated onto robot 102 in an integrated system. Moreover, in some cases, a person having ordinary skill in the art would appreciate from the contents of this disclosure that at least a portion of the features described in this disclosure may also be run remotely, such as in a cloud, network, and/or server.

As used herein, a robot 102, a controller 118, or any other controller, processor, or robot performing a task, operation, or transformation illustrated in the figures below comprises a controller executing computer readable instructions stored on a non-transitory computer readable storage apparatus, such as memory 120, as would be appreciated by one skilled in the art.

Next referring to FIG. 1B, the architecture of a processor or processing device 138 is illustrated according to an exemplary embodiment. As illustrated in FIG. 1B, the processor 138 includes a data bus 128, a receiver 126, a transmitter 134, at least one processor 130, and a memory 132. The receiver 126, the processor 130, and the transmitter 134 all communicate with each other via the data bus 128. The processor 130 is configurable to access the memory 132, which stores computer code or computer readable instructions in order for the processor 130 to execute the specialized algorithms. As illustrated in FIG. 1B, memory 132 may comprise some, none, different, or all of the features of memory 120 previously illustrated in FIG. 1A. The algorithms executed by the processor 130 are discussed in further detail below. The receiver 126 as shown in FIG. 1B is configurable to receive input signals 124. The input signals 124 may comprise signals from a plurality of operative units 104 illustrated in FIG. 1A, including, but not limited to, sensor data from sensor units 114, user inputs, motor feedback, external communication signals (e.g., from a remote server), and/or any other signal from an operative unit 104 requiring further processing. The receiver 126 communicates these received signals to the processor 130 via the data bus 128. As one skilled in the art would appreciate, the data bus 128 is the means of communication between the different components—receiver, processor, and transmitter—in the processing device. The processor 130 executes the algorithms, as discussed below, by accessing specialized computer-readable instructions from the memory 132. Further detailed description as to the processor 130 executing the specialized algorithms in receiving, processing, and transmitting of these signals is discussed above with respect to FIG. 1A. The memory 132 is a storage medium for storing computer code or instructions. The storage medium may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage medium may include volatile, nonvolatile, dynamic, static, read/write, read-only, random-access, sequential-access, location-addressable, file-addressable, and/or content-addressable devices. The processor 130 may communicate output signals to transmitter 134 via data bus 128 as illustrated. The transmitter 134 may be configurable to further communicate the output signals to a plurality of operative units 104 illustrated by signal output 136.

One of ordinary skill in the art would appreciate that the architecture illustrated in FIG. 1B may illustrate an external server architecture configurable to effectuate the control of a robotic apparatus from a remote location. That is, the server may also include a data bus, a receiver, a transmitter, a processor, and a memory that stores specialized computer readable instructions thereon.

One of ordinary skill in the art would appreciate that a controller 118 of a robot 102 may include one or more processors 138 and may further include other peripheral devices used for processing information, such as ASICS, DPS, proportional-integral-derivative (“PID”) controllers, hardware accelerators (e.g., encryption/decryption hardware), and/or other peripherals (e.g., analog to digital converters) described above in FIG. 1A. The other peripheral devices, when instantiated in hardware, are commonly used within the art to accelerate specific tasks (e.g., multiplication, encryption, etc.), which may alternatively be performed using the system architecture of FIG. 1B. In some instances, peripheral devices are used as a means for intercommunication between the controller 118 and operative units 104 (e.g., digital to analog converters and/or amplifiers for producing actuator signals). Accordingly, as used herein, the controller 118 executing computer readable instructions to perform a function may include one or more processors 138 thereof executing computer readable instructions and, in some instances, the use of any hardware peripherals known within the art. Controller 118 may be illustrative of various processors 138 and peripherals integrated into a single circuit die or distributed to various locations of the robot 102 which receive, process, and output information to/from operative units 104 of the robot 102 to effectuate control of the robot 102 in accordance with instructions stored in a memory 120, 132. For example, controller 118 may include a plurality of processors 138 for performing high-level tasks (e.g, planning a route to avoid obstacles) and processors 138 for performing low-level tasks (e.g., producing actuator signals in accordance with the route).

Next, FIGS. 2A(i-ii) will be discussed. FIGS. 2A(i-ii) illustrates a light detection and ranging (“LiDAR”) sensor 202 coupled to a robot 102, which collects distance measurements to an object, such as wall 206, along a measurement plane in accordance with some exemplary embodiments of the present disclosure. LiDAR sensor 202, illustrated in FIG. 2A(i), may be configured to collect distance measurements to the wall 206 by projecting a plurality of beams 208 of photons at discrete angles along a measurement plane, and determine the distance to the wall 206 based on a time of flight (“ToF”) of the photons leaving the LiDAR sensor 202, reflecting off the wall 206, and returning back to the LiDAR sensor 202. The measurement plane of the LiDAR 202 comprises a plane along which the beams 208 are emitted, which, for this exemplary embodiment illustrated, is the plane of the page. In some embodiments, LiDAR sensor 202 may emit beams 208 across a two-dimensional field of view instead of a one-dimensional planar field of view, wherein the additional dimension may be orthogonal to the plane of the page.

Individual beams 208 of photons may localize a respective point 204 of the wall 206 in a point cloud, the point cloud comprising a plurality of points 204 localized in 2D or 3D space as illustrated in FIG. 2(ii). The location of the points 204 may be defined about a local origin 210 of the sensor 202 and is based on the ToF of the respective beam 208 and the angle at which the beam 208 was emitted from the sensor 202. Distance 212 to a point 204 may comprise half the time of flight of a photon of a respective beam 208 used to measure the point 204 multiplied by the speed of light, wherein coordinate values (x, y) of each point 204 depends both on distance 212 and an angle at which the respective beam 208 was emitted from the sensor 202. The local origin 210 may comprise a predefined point of the sensor 202 to which all distance measurements are referenced (e.g., location of a detector within the sensor 202, focal point of a lens of sensor 202, etc.). For example, a 5-meter distance measurement to an object corresponds to 5 meters from the local origin 210 to the object.

According to at least one non-limiting exemplary embodiment, a laser emitting element of the LiDAR sensor 202, which emits the beams 208, may include a spinning laser, wherein the individual beams 208 illustrated in FIG. 2A(i-ii) may correspond to discrete measurements of the ToF of the laser.

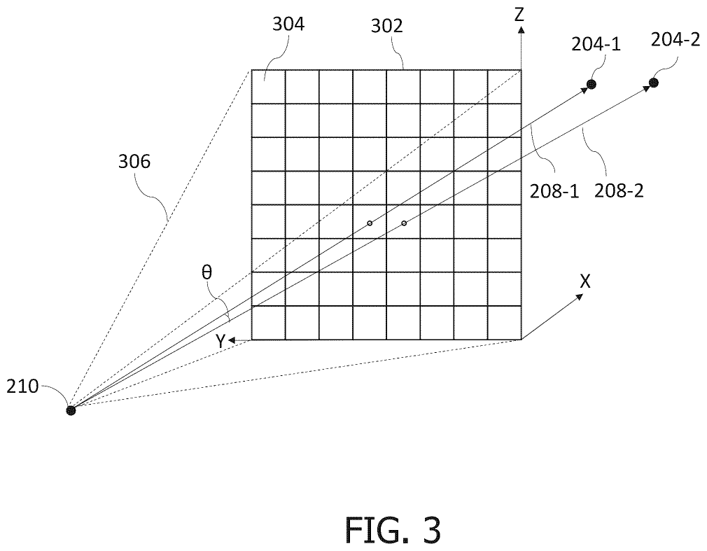

According to at least one non-limiting exemplary embodiment, sensor 202 may be illustrative of a depth camera or other ToF sensor configured to measure distance, wherein the sensor 202 being a planar LiDAR sensor is not intended to be limiting. Depth cameras may operate similarly to planar LiDAR sensors (i.e., measure distance based on a ToF of beams 208); however, depth cameras may emit beams 208 using a single pulse or flash of electromagnetic energy, rather than sweeping a laser beam across a field of view. Depth cameras may additionally comprise a two-dimensional field of view. A depth camera is further illustrated below in FIG. 3.

According to at least one non-limiting exemplary embodiment, sensor 202 may be illustrative of a structured light LiDAR sensor configured to sense distance and shape of an object by projecting a structured pattern onto the object and observing deformations of the pattern due to the presence of objects. For example, a structured light sensor may emit a line of light as the pattern, wherein the size of the line pattern may represent distance to the object (e.g., smaller line corresponding to farther objects) and distortions in the line (e.g., discontinuities of the line) may provide information of the shape of the surface of the object. Structured light sensors may emit beams 208 along a plane as illustrated or in a predetermined pattern (e.g., a circle or series of separated parallel lines).

FIG. 2B illustrates a robot 102 comprising an origin 216 defined based on a transformation 214 to a world origin 220, according to an exemplary embodiment. World origin 220 may comprise a fixed or stationary point in an environment of the robot 102 that defines a static (0, 0, 0) origin point within the environment. Origin 216 of the robot 102 may define a location of the robot 102 within its environment. For example, if the robot 102 is at a location (x=5 m, y=5 m, z=0 m), then origin 216 is at a location (5, 5, 0) with respect to the world origin 220. The origin 216 may be positioned anywhere inside or outside the robot 102 body, such as, for example, between two wheels of the robot at z=0 (i.e., on the floor). The transform 214 may represent a matrix of values that configures a change in coordinates from being centered about the world origin 220 to the origin 216 of the robot 102. The value(s) of transform 214 may be based on a current position of the robot 102 and may change over time as the robot 102 moves, wherein the current position may be determined via navigation units 106 and/or using data from sensor units 114 of the robot 102 to update and maintain accurate values for transform 214.

The robot 102 may include one or more exteroceptive sensors 202 of sensor units 114, one sensor 202 being illustrated, wherein each sensor 202 includes an origin 210. The positions of the sensor 202 may be fixed onto the robot 102 such that its origin 210 does not move with respect to the robot origin 216 as the robot 102 moves. Measurements from the sensor 202 may include, for example, distance measurements, wherein the distances measured correspond to a distance from the origin 210 of the sensor 202 to one or more objects. Transform 218 may define a coordinate shift from being centered about an origin 210 of the sensor 202 to the origin 216 of the robot 102, or vice versa. Transform 218 may be a fixed value, provided the sensor 202 does not change its position. In some embodiments, sensor 202 may be coupled to one or more actuator units 108 configured to change the position of the sensor 202 on the robot 102 body, wherein the transform 218 may further depend on the current pose of the sensor 202. It is appreciated that all origins 210, 216, and 220 are points comprising no area, volume, or spatial dimensions and are defined only as a location.

Controller 118 of the robot 102 may always localize the robot origin 216 with respect to the world origin 220 during navigation, using transform 214 based on the robot 102 motions and position in the environment, and thereby localize sensor origin 210 with respect to the robot origin 216, using a fixed transform 218, and world origin 220, using transforms 214 and 218. In doing so, the controller 118 may convert locations of points 204 defined with respect to sensor origin 210 to locations defined about either the robot origin 216 or world origin 220. For example, transforms 214, 218 may enable the controller 118 of the robot 102 to translate a 5 meter distance measured by the sensor 202 (defined as a 5-m distance between a point 204 and origin 210) into a location of the point 204 with respect to the robot origin 216 (e.g., distance of the point 204 to the robot 102) or world origin 220 (e.g., location of the point 204 in the environment). Stated differently, transforms 214, 218 may translate a 5 m distance measured between the sensor origin 210 and a point 204 to a distance from the robot origin 216 and/or a distance from the world origin 220.

It is appreciated that the position of the sensor 202 on the robot 102 is not intended to be limiting. Rather, sensor 202 may be positioned anywhere on the robot 102 and transform 218 may denote a coordinate transformation from being centered about the robot origin 216 to the sensor origin 210, wherever the sensor origin 210 may be. Further, robot 102 may include two or more sensors 202 in some embodiments, wherein there may be two or more respective transforms 218, which denote the locations of the origins 210 of the two or more sensors 202. Similarly, the relative position of the robot 102 and world origin 220 as illustrated is not intended to be limiting.

The following figures may illustrate various pixels and/or voxels. It is appreciated by one skilled in the art that the size of the pixels and/or voxels has been exaggerated for purposes of clarity. Further, sensors 202 are depicted throughout, wherein the resolution of these sensors 202 are reduced for clarity. Lastly, in some figures, computer readable maps are depicted, wherein one skilled in the art may appreciate that the illustrated maps may represent a portion of a larger map, which is not illustrated for clarity, and the resolutions of the maps are reduced (i.e., sizes of the pixels of the maps are increased) for clarity.

FIG. 2C illustrates a robot 102 comprising a LiDAR sensor 202, according to an exemplary embodiment. The LiDAR sensor 202 may emit either a plurality of pulses or a continuous signal of electromagnetic energy into the environment to measure distance to objects based on the ToF of the pulses or signal. Some LiDAR sensors 202 may calculate the ToF based on a phase difference between the emitted signal and the received signal. For example, if the emission signal includes a period of 1 second and a returning signal includes a phase offset of π (or 180°), then the ToF of the signal from emission to an encounter with an object is 0.25 seconds, wherein the distance is 0.25c m with c being the speed of light.

FIG. 2C illustrates one exemplary scenario and embodiment of LiDAR sensor 202, which may cause a robot 102 to perceive a floor at a greater height than the floor truly is located. In the illustrated scenario the illustrated beam 208 comprises a total ToF (i.e., from emission to detection by the sensor 202) greater than its emission period. That is, in the phase-domain, the phase difference of the returning beam is greater than 2π, denoted as 2π+n with n being 0<n<2π (corresponding to the phase offset. The phase corresponds to the phase of the emission cycle of the sensor 202 emitting beams 208 (i.e., a 2π phase corresponds to the time to emit 2 beams 208). For simplicity herein, it may be presumed the phase difference cannot reach 3π or greater as often beams traveling this far may not comprise sufficient power to be sensed by the detector. In the illustrated scenario, due to the reflection with the floor 224 and wall 226 prior to the beam 208 returning to the sensor, the phase difference of any emitted beam 208 from emission to detection is greater than 2π, causing two pulses 222 and 222-R to be traveling within the environment at the same time. Pulses 222, 222-R may represent two discrete pulses or two samples of a continuous signal. Pulses 222, 222-R are emitted from the sensor 202 at time corresponding to a 2π phase difference (e.g., 1 second in the example above). However, due to the pulse 222-R taking longer than the emission period to be returned, the sensor 202 may mistake the pulse 222-R as being the reflection of the emitted pulse 222 rather than being correlated to the prior pulse. Accordingly, the distance is underestimated, yielding an erroneous point 228 which is closer to the sensor 202.

To further illustrate the scenario in FIG. 2C, some LiDAR sensors 202 may utilize discrete pulses, wherein the discrete pulses may be emitted as a periodic sequence. The pulses of the sequence may each be modulated with one or more unique frequency/frequencies, last different durations in time, and/or comprise different amplitudes such that each pulse may be discerned from other pulses emitted from the LiDAR sensor 202 in the sequence. These pulses may be emitted in a predetermined order (e.g., pulse A, B, C, D, with each of pulses A, B, C, and D, including one or more unique modulation characteristics) which repeats after the period of time (e.g., the pulses are emitted in the order A, B, C, D, A, B, C, D, and so forth). For LiDAR sensors 202, which utilize a continuously transmitted signal, the signal itself may repeat after its period.

Errors in localization may occur when the phase difference of the emitted signal and the received signal exceeds 2π In the scenario illustrated in FIG. 2C, the LiDAR sensor 202 emits a beam 208 into the environment which reflects (specular reflection) off a shiny floor 224, reflects (diffusely) off an object 226, and is returned to the depth camera 202 following a path of beam 208 and reflected beam 208-R. The beam 208 may represent a plurality of discrete pulses or a continuously transmitted electromagnetic signal, described above, comprising a periodic signal. The beam 208 includes sub-signal or pulse 222 representative of either a single pulse or a sample of a continuously transmitted signal. Reflected beam 208-R further includes the same sub-signal 222-R, wherein the two sub-signals 222 are separated by a 2π+n phase difference (0<n<2π). For example, LiDAR sensor 202 may emit a sequence of discrete pulses A, B, C, D, A, B, C, D, A, and so on, with each of the pulses being unique from others in the sequence (e.g., pulse A may last longer than pulse B, pulse C may include a different frequency than pulse B, etc.), wherein the two sub-signals 222 and 222-R illustrated may include the first pulse A and the second pulse A in the sequence. The phase difference between the detection of the sub-signal 222-R of the reflected beam 208-R and emission of the sub-signal 222-R may be 2π+n. In some instances, the LiDAR sensor 202 may not be able to determine that the phase difference has exceeded 2π and may instead erroneously determine that (i) the first emitted sub-signal 222-R was never reflected back to the sensor 202, and (ii) the receipt of the reflected beam 208-R sub-signal 222-R corresponds to the ToF of the sub-signal 222 of the emitted beam 208, causing the phase difference to be n rather than 2π+n, which may be greatly underestimated. This underestimation of the phase difference correlates to an underestimated ToF, and thereby an underestimated distance of a point 228.

Further, the LiDAR sensor 202 is not aware of the reflection of the beam 208 off of the reflective floor 224 and maps the location of the point 204 at a distance along the path of beam 208 prior to its reflection off of the floor. To illustrate where the point 204 may be localized in the illustrated scenario, two points 226 (black) and 228 (white) are shown. Point 226 shows the correct location of a point 204 measured by the sensor 202 if no reflection occurred (i.e., if sub signal 222-R was received prior to sub-signal 222 being emitted). Point 228 shows the incorrect location of the point 204 if the reflection occurs as described above (i.e., the point 228 was localized by a sub-signal 222 comprising a 2π+N phase difference between emission and detection of the sub-signal 222. The distance of the point 228 from the sensor 202 corresponds to a phase shift of N, and not 2π+N). This may cause the floor 224, as sensed by the sensor 202, to appear above a z=0 plane, especially in scenarios where the robot 102 is navigating nearby objects and on a reflective/shiny floor. Accordingly, simply denoting all points 204 which lie on z=0 plane, with some tolerance, is not sufficient in detecting floor surrounding the robot 102. The following disclosure aims to detect floor surrounding the robot 102 without relying on the measured height of points 204.

Although FIG. 2C illustrates one exemplary scenario in which a sensor 202 may erroneously localize a floor 224, various other phenomenon known within the art may cause a LiDAR sensor 202 to incorrectly localize a floor, such as noise and poor calibration of the sensor. The systems and methods below may account for a wide variety of error sources (e.g., noise, wrap-around effect, calibration, etc.) to detect floor, wherein FIG. 2C is not intended to limit the sources of erroneous localization of a floor 224 or other objects.

One skilled in the art may appreciate that improper localization of a floor, upon which the robot 102 navigates, may cause the robot 102 to falsely perceive it is surrounded by impassable objects. Especially if the floor is improperly localized at a height above what is expected. Accordingly, the systems and methods below enable a robot 102 to, in the presence of noise or improper localization, identify the navigable floor space around itself. In some embodiments, the methods herein may be executed continuously as the robot 102 operates in real-time or upon the robot 102 detecting it is surrounded by (unforeseen) objects as a method to verify the objects are real objects or improperly localized floor.

FIG. 3 illustrates an image plane 302 of a sensor 202 in accordance with some exemplary embodiments of this disclosure. In the illustrated embodiment, the LiDAR sensor 202 is a depth camera including a two-dimensional field of view. Image plane 302 may comprise a size (i.e., width and height) corresponding to a field of view of a sensor 202, the size being integer numbers of pixels 304 along either dimension. Image plane 302 may comprise a plane upon which a visual scene is projected on to produce, for example, images (e.g., RGB images, depth images, etc.). The image plane 302 is analogous to the plane formed by a printed photograph on which a visual scene is depicted. The image plane 302 subtends a solid angle about the origin 210 corresponding to a field of view of the sensor 202, the field of view being illustrated by dashed lines 306, which denote the edges of the field of view.

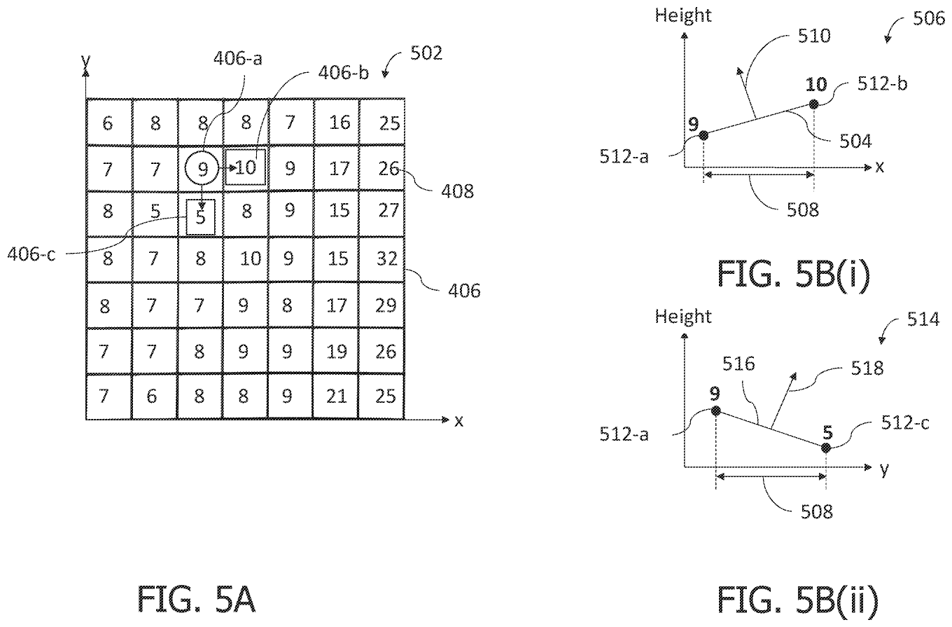

Image plane 302 may include a plurality of pixels 304. Each pixel 304 may include or be encoded with distance information and, in some instances, color information. The distance information is measured based on a ToF of beams 208 passing through a respective pixel 304 (as shown by dots in the centers of the two pixels 304 corresponding to the two illustrated beams 208), reflecting off an object and back to a detector of the depth camera 202. Points 204 localize a surface of the object. If the depth camera 202 is configured to produce colorized depth imagery, each pixel 304 of the plane 302 may include a color value equal to the color of the visual scene as perceived by a point observer at a location of a sensor origin 210 (e.g., using data from color-sensitive sensors, such as CCDs and optical filters). The distance and color information for each pixel 304 may be stored as a matrix in memory 120 or as an array (e.g., by concatenating rows/columns of distance and color information for each pixel 304) for further processing, as shown in FIGS. 4 and 5A-B below.

For planar LiDAR sensors configured to measure distance along a measurement plane, the image plane 302 may instead comprise a one-dimensional (i.e., linear) row of pixels 304. The number of pixels 304 along the row may correspond to the field of view n of the planar LiDAR sensor. The solid angle subtended by each individual pixel 304 corresponds to an angular resolution of the sensor 202.

By way of an analogous visual illustration, if the image plane 302 is an opaque surface and one pixel 304 is removed or made transparent to allow for viewing of a visual scene behind the opaque surface through the “removed/transparent” pixel 304, the color value of the pixel 304 may be the color seen by an observer at the origin 210 looking through the “removed/transparent” pixel 304. Similarly, the depth value may correspond to the distance between the origin 210 to an object as traveled by a beam 208 through the “removed” pixel 304. It is appreciated, following the analogy, that depth cameras 202 may “look” through each pixel contemporaneously by emitting flashes or pulses of beams 208 through each pixel 304.

The number of pixels 304 may correspond to the resolution of the depth camera 202. In the illustrated embodiment, simplified for clarity, the resolution is only 8×8 pixels; however, one skilled in the art may appreciate depth cameras may include higher resolutions, such as, for example, 240×240 pixels, 1080×1080 pixels, or larger. Further, the resolution of the depth camera 202 is not required to include the same number of pixels along the horizontal (i.e., y) axis as the vertical (i.e., z) axis (e.g., 1090×1080 px).

Depth imagery may be produced by the sensor emitting a beam 208 through each pixel 304 of the image plane 302 to record a distance measurement associated with each pixel 304, the depth image being represented based on a projection of the visual scene onto the image plane 302 as perceived by an observer at origin 210. Depth imagery may further include color values for each pixel 304 if the sensor 202 is configured to detect color or greyscale representations of color, the color value of a pixel 304 being the color as perceived by a point observer at the origin 210 viewing a visual scene through each pixel 304. The size (in steradians) of the pixels 304 may correspond to a resolution of the resulting depth image and/or sensor. The angular separation between two horizontally adjacent beams θ may be the angular resolution of the depth image, wherein the vertical angular resolution may be of the same or different value.

Depth imagery may be utilized to produce a point cloud, or a plurality of localized points 204 in 3-dimensional (“3D”) space, each point comprising no volume and a defined (x, y, z) position. Each point 204 typically comprises non-integer (i.e., non-discrete) values for (x, y, z), such as floating-point values. It may be desirable for a robot 102 to identify objects within its environment to avoid collisions and/or perform tasks. Robotic devices may utilize one or more computer readable maps to navigate and perceive their environments, wherein the use of raw point cloud data may be computationally taxing and may be inaccurate because the points do not define volumes of objects. Accordingly, point clouds are discretized into voxel space and projected into a two-dimensional (“2D”) plane to form maps, which enable the controller 118 to more readily utilize the point cloud data to perceive its surrounding environment.

Voxels, as used herein, may comprise 3D pixels, or non-overlapping rectangular prisms of space with a defined width, height, and length, wherein the width, height, and length may be of the same or different values. In some embodiments, voxels may be other non-overlapping 3-dimensional shapes, such as, for example, voxels defined using spherical or cylindrical coordinates. In some embodiments, the dimensions of each voxel may vary as the depth of the voxel from the origin 210 varies in some coordinate systems, such as, e.g., spherical or cylindrical coordinates. To simplify the below description and illustrations, each voxel as shown and described hereinafter may be defined by Cartesian coordinates and comprise cubes which include width, height, and length dimensions of the equivalent values unless specifically stated otherwise. There is no correlation between the size/shape of pixels 304 of an image plane 302 with the size/shape of the voxels shown below. Further, voxels may be defined with respect to a world origin 220 and may be stationary with respect to a moving robot 102.

FIG. 4A illustrates a robot 102 comprising a depth camera 202 navigating through an environment, according to an exemplary embodiment. The controller 118 of the robot 102 may utilize the depth camera 202 to capture a depth image of a scene by projecting a plurality of beams 208 of electromagnetic energy into the environment. Each beam 208 may, assuming a reflection thereof reaches back to the sensor 202, localizes a point 204 at the surface of any object within the field of view such as the robot 102 itself, the floor, and/or a wall 400 (representative of any object), wherein only some beams 208 are illustrated while the majority are omitted for clarity.

FIG. 4B illustrates the plurality of points 204 shown in FIG. 4A in voxel coordinate space, according to an exemplary embodiment. The voxels 402 illustrated may comprise a slice of a 3-dimensional (“3D”) volume of voxels 402, wherein the slice comprises a vertical component (z) and a horizontal component (x or y) and a depth of one voxel 402. The voxels 402 may remain in static positions relative to the environment and are defined with respect to the world origin 220. A LiDAR sensor 202 may collect distance measurements between its origin 210 and objects within a visual scene, the objects being represented by points 204, which localize surfaces of the objects. Beams 208 corresponding to some points 204 are illustrated; however, it is appreciated that each point 204 is localized by its respective beam 208, and some beams 208 are omitted for clarity, wherein each beam 208 corresponds to a pixel 304 of the image plane 302 of the LiDAR sensor 202.

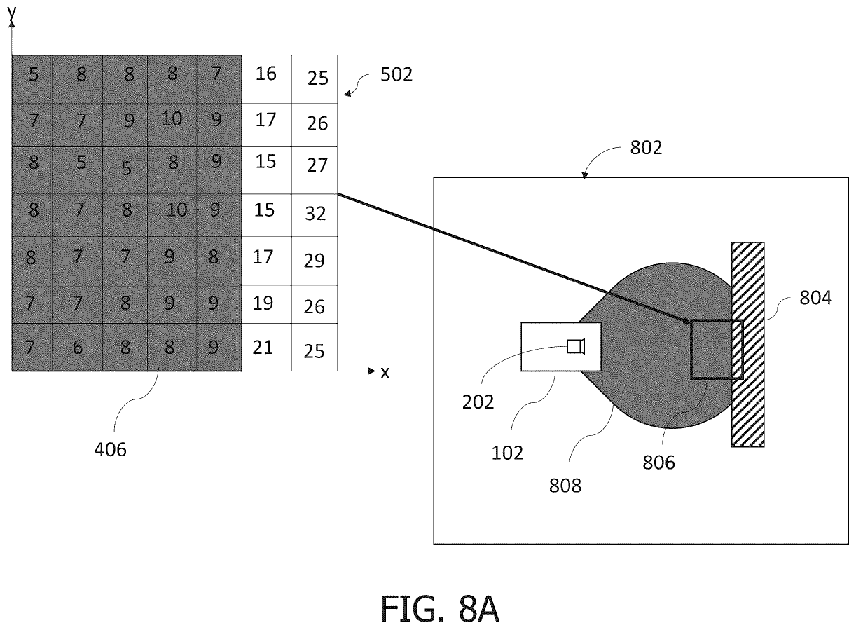

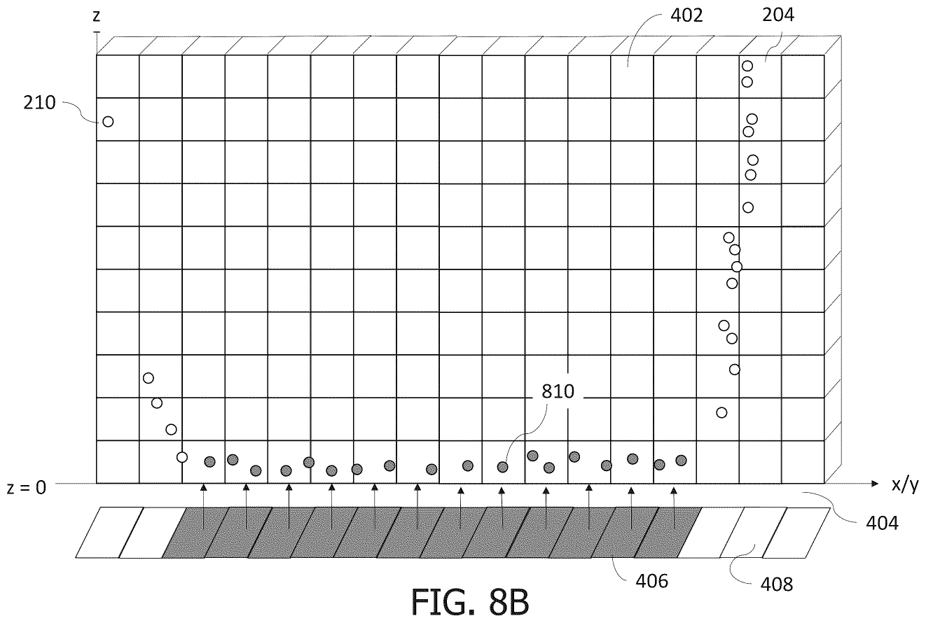

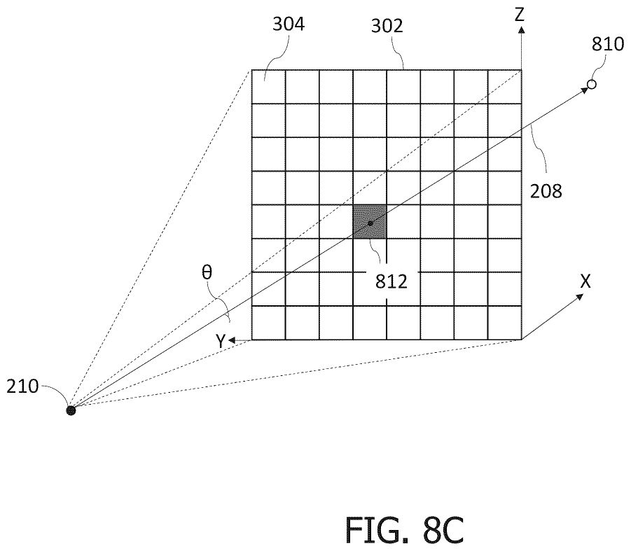

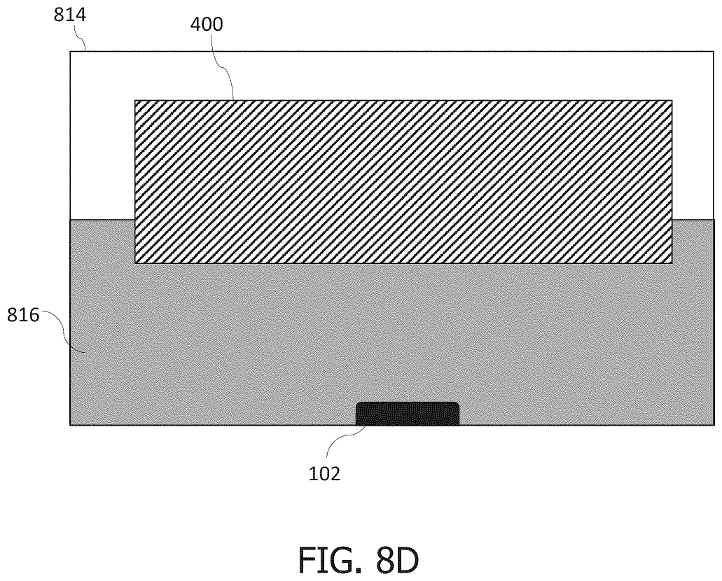

Points 204 within circle 410 may correspond to distance measurements that sense a portion of the robot 102 body, points in circle 412 may sense the floor, and the remaining points 204 within circle 414 may correspond to a vertically oriented surface, such as a wall. One skilled in the art may appreciate that other environments may generate points 204 at different locations. The points 204 may correspond to the arrangement of sensor 202, robot 102, and a wall 804 as shown in FIG. 8, for example.

Each point 204 may fall within a voxel 402 at some height above a floor (i.e., a z=0 plane). The controller 118 of the robot 102 may utilize the data from points 204 to create a height map of the environment. The height map may correspond to a 2-dimensional (“2D”) representation of the environment comprising a plurality of pixels 406; a single row of pixels 406 is illustrated. One skilled in the art may appreciate that the slice of voxels 402 corresponds to a row of pixels 406 when projected into 2D, wherein a height map may include additional rows of pixels 406 beneath other slices of voxels 402 not illustrated for clarity. The projection of the 3D volume of points 204 from voxel space to pixel space is shown by projection lines 404. Each pixel 406 may be encoded with a height value based on an average height (i.e., z) value of the points 204 above the pixel 406. In the illustrated embodiment, the lowest row of voxels 402 correspond to z=0 height as shown, however in some instances (e.g., poor calibration) voxels may be defined below the z=0 axis. Accordingly, pixels 406 include a height value 408 corresponding to the average height of all points 204 within the voxels 402 above the respective pixels 406 in units of voxels. Although integer numbers are illustrated for height values 408, other embodiments may utilize non-integer height values, such as floating-point values (e.g., a height value 408 may be 7.42 voxels).

According to at least one non-limiting exemplary embodiment, points 204 above a specified height threshold may not be considered during the projection onto the height map pixels 406. For example, points 204 above the z=10 voxel 402 are not considered when calculating values 408 for the height map pixels 406. For example, points 204 at such heights may correspond to ceiling, ledges, or high-up shelves which do not impact the shape/height of the floor, nor impact the height map 502 in a substantial way as discussed below. The height threshold may, in some embodiments, correspond to a height that is as tall or taller than the height of the robot 102, wherein the robot 102 may not be concerned with any objects above itself which do not pose a risk of collision.

FIG. 5A illustrates a top-down view of a height map 502, according to an exemplary embodiment. The height map 502 may comprise a plurality of rows of pixels as described in FIG. 4B. In the illustrated embodiment, the height values 408 of the height map 502 represents the height of points 204 above an x-y plane at z=0, where the z=0 plane represents the floor; however, the height values 408 of the pixels 406 are all above zero. Some pixels 406 may represent floor and include a non-zero height value 408 if, for example, the sensor 202 is poorly calibrated and/or due to excessive environmental noise (e.g., bright broad-band light or wrap-around effect described in FIG. 2C). Other values may be used for the height of the floor (i.e., the plane of the floor may be defined in any reference coordinate system), as appreciated by one skilled in the art. As shown, each pixel 406 includes a non-zero height value 408. Pixels 406, which represent floor, may include a non-zero height value 408 due to, for example, calibration error and/or excessive sensor noise.

The values 408 of the pixels 406 are arbitrarily assigned in this exemplary embodiment. One skilled in the art may appreciate that the following method of detecting floor using the height map 502 is equally applicable if, e.g., (i) one or more of the values 408 equal zero, or (ii) one or more of the values 408 is less than zero.

To determine which pixels 406 represent floor, a controller 118 may utilize the topography of the height map 502. Pixels 406, which represent floor space, are expected to be substantially flat. For example, by comparing the height values 408 of two adjacent pixels 406, controller 118 may determine an approximate slope of the surface/objects present in the area represented by the pixels 406 to analyze the topography. The slope of the height map may be useful in determining which pixels 406 are floor and which pixels 406 are occupied by an object, such as wall 400, because floor space should include an approximately zero, or flat, slope. Stated differently, if pixels 406 represent floor, it would be expected that a surface normal unit vector of the slope represented by the height map 502 are substantially vertical. Controller 118 may, for any given pixel 406, such as pixel 406-a, utilize height values 408 from two neighboring pixels 406, a first neighboring pixel 406-c along the y axis and a second neighboring pixel 406-b along an orthogonal x axis. In the illustrated embodiment, the controller 118 calculates the slope of the height map proximate the circled pixel 406-a, which includes a height value of nine (9). The neighboring pixels used for the calculation include a first pixel 406-b along the y axis with a height value 408 of five (5) and a second pixel 406-c along the x axis with a height value 408 of ten (10). In some embodiments, other height values 408 of different neighboring pixels 406 may be utilized instead of or in addition to the illustrated neighboring pixels 406 (e.g., the controller 118 may utilize neighboring pixels 406 along the −x and/or +y directions, with height values 408 of seven (7) and eight (8) respectively).

It is appreciated that, in some instances, one or more pixels 406 of height map 502 may include no height value 408 (e.g., a NULL value). For example, in FIG. 4B, no points 204 lie above the leftmost and rightmost pixels 406 as shown, wherein these two pixels 406 may include no height value 408 or a NULL height value 408. If, for any given pixel 406-a, a neighboring pixel 406-b along a first (x or y) axis includes no height value 408, the controller 118 may instead utilize the height value 408 of the neighboring pixel 406-b along the first axis in the opposing direction (i.e., −x or −y direction). Pixels 406 comprising no height measurement 408 may not represent floor space as there is insufficient data (i.e., lack of points 204) to definitively determine that these pixels 406 represent floor, and are accordingly never denoted as floor space as a safety precaution.

FIG. 5B(i) illustrates a line segment 504 along the x-axis of height map 502 which represents a slope between center points 512-a and 512-b of two pixels 406-a and 406-b, respectively, according to an exemplary embodiment. In graph 506, the slope along the x-direction of the height map 502 is calculated and shown by vector 510. Specifically, the slope of graph 506 illustrates the slope between height values 408 of pixel 406-a and pixel 406-b. The horizontal axis of graph 506 represents the x-axis of height map 502, wherein the horizontal separation 508 between the two points is equal to the spatial resolution (i.e., size) of pixels 406. The vertical axis represents the magnitude of the height values 408 for the two neighboring pixels 406-a and 406-b, labeled as nine (9) and ten (10) respectively. Based on the magnitude difference (i.e., 9-10) and the spatial separation (i.e., resolution of the pixels 406), a slope of line 504 is calculated, and an x-component of a surface normal vector as shown by vector 510, which is normal to the slope of line 504, may be determined.

To calculate the slope of the line segment 504, and thereby the direction of vector 510, the controller 118 may, for any given pixel 406-a of the height map 502, calculate a line segment between the center point of the given pixel 406-a and a neighboring pixel 406-b. The slope of the line segment may be calculated using:

$$m = \frac{{h}_{1} - {h}_{2}}{r} \qquad ( Eqn . 1 )$$

where h₁ and h₂ are height values 408 for the given pixel 406-a and the neighboring pixel 406-b, respectively; m is the slope, and r is the spatial resolution (i.e., spatial size) of each pixel 406 along the x or y directions. The direction of the vector component 510 (or 518, shown in FIG. 5B(ii) next) is normal to the line segment m. The line segment of equation 1 may be calculated at least twice using the height values 408 of the given pixel 406-a and a first neighboring pixel 406-b along a first axis and a second neighboring pixel 406-c along a second axis orthogonal to the first. The second calculation is shown below in FIG. 5B(ii). By performing these calculations, controller 118 may measure two orthogonal components 510, 518 of a unit vector which is normal to the slope of the height map at the pixel 406-a, wherein the unit vector is a normalized cross product of the two orthogonal components.

Next, in FIG. 5B(ii), graph 514 illustrates a line segment 516 representing the slope between height values 408 of pixels 406-a and 406-c of height map 502 along the y-axis, according to an exemplary embodiment. Segment 516 is defined by two points 512-a and 512-c representing the height values 408 of two neighboring pixels 406-a and 406-c, respectively, along the y-axis of height map 502. Graph 514 includes a horizontal component, illustrative of the y-axis separation in height map 502 between two pixels 406-a and 406-c, and a vertical component, illustrative of the magnitude of height values 408 of the two pixels 406-a and 406-c. In the illustrated embodiment, because pixels 406 are squares, the horizontal (i.e., y) separation is equal to distance 508 shown in graph 506, but this is not limiting if the pixels 406 are not squares. Based on the difference in height value 408 magnitude (i.e., 9-5) and the spatial separation 508 along the y-axis, vector 518 may be calculated. Vector 518 is the unit normal vector to segment 516 and y-component of the surface normal unit vector 602 for the encircled pixel 406 of height map 502.

According to at least one non-limiting exemplary embodiment, the controller 118 may utilize additional calculations to determine the unit vector for each pixel 406. For example, in the illustrated embodiment, the controller 118 utilizes the height values 408 of the nearest neighboring pixels 406 along the +x and −y directions. In addition to the illustrated calculations, the controller 118 may further calculate vector components 510 and 518 using height values 408 of neighboring pixels 406 along the −x and +y direction (i.e., using respective values 7 and 8) and average the two calculations together. In some embodiments, the controller 118 may utilize height values 408 of non-neighboring pixels 406, such as between the encircled pixel 406 and a pixel 406 two pixels away along the +x axis, including the value of twelve (12), and two pixels away along the −y axis, including the value of eleven (11). In some embodiments, controller 118 may utilize height values 408 of diagonally adjacent pixels to determine the slope of the height map for pixel 406-a. For example, controller 118 may utilize the height value 408 of pixel 406-a and any two or more height values 408 of the diagonally adjacent pixels 406 (e.g., the pixels 406, including the height values of 8 or 5 as shown by height map 502).

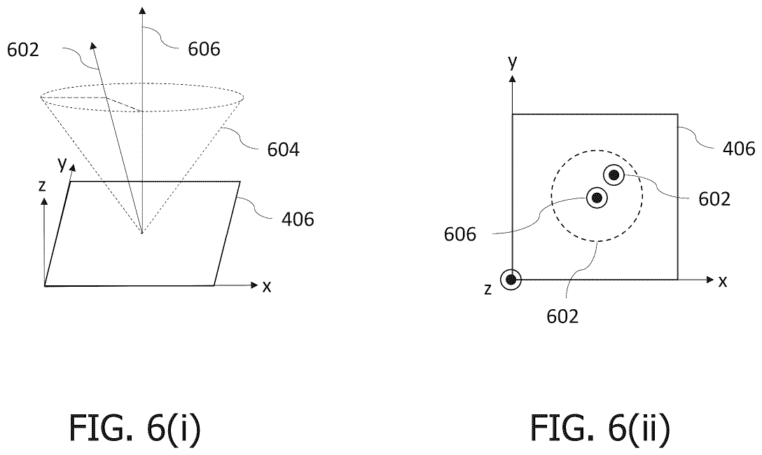

The unit vector 602, shown in FIG. 6(i-ii), for each pixel 406 may then be calculated using the cross product of the x component 510 and the y component 518. A controller 118 may calculate the unit vectors 602 for each pixel 406 of the height map 502 following substantially similar methods.

FIG. 6(i) illustrates a pixel 406 and a calculated surface normal unit vector 602 for the pixel 406, according to an exemplary embodiment. To determine if the pixel 406 corresponds to floor, the unit vector 602 must be within a threshold deviation 604 from an reference surface normal 606, the reference surface normal 606 being a vector pointed straight upwards along the z axis which includes no x or y components. As shown, the calculated unit vector 602 may fall within threshold 604 and may therefore be determined to correspond to floor. FIG. 6(i-ii) illustrates the same pixel 406 from a top-down view, wherein vector 606 is within threshold 602 from vector 606 as shown from a different perspective.

Although the pixel 406 is illustrated as being flat along the plane of the height map 502 (i.e., z=0), height values 408 of the height map 502 may provide the controller 118 with data sufficient to calculate the topography of the environment based on the height map 502 using surface normal unit vectors 602 for each pixel 406. That is, surface normal unit vectors 602 are calculated based on the difference in height values 408 of pixels 406 of height map 502 and are not normal to the surface of pixel 406; rather, vectors 602 are approximately normal to the slope of the height map 502 (i.e., the slope of the environment topography) for any given pixel. Accordingly, “surface normal” of vector 602 refers to a vector that is normal to the topography of the height map.

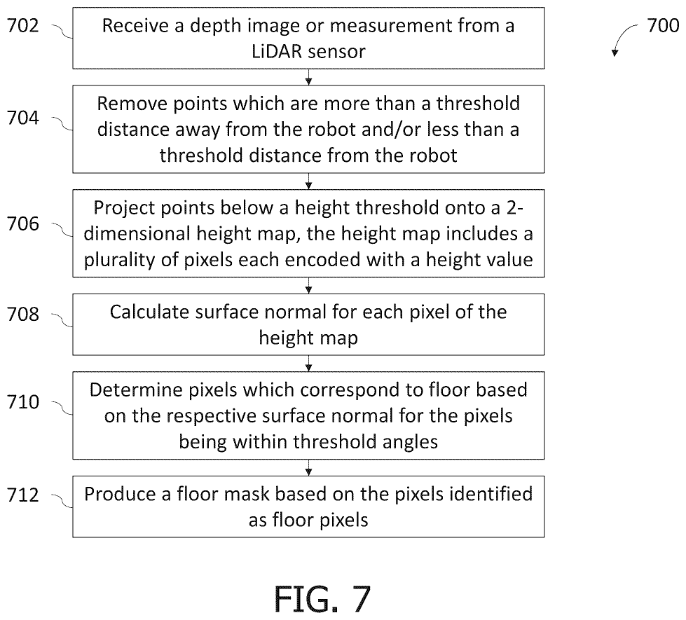

FIG. 7 is a process flow diagram illustrating a method 700 for a controller 118 of a robot 102 to detect and map floor within its environment using depth measurements from a sensor 202, according to an exemplary embodiment. Sensor 202 may include a LiDAR sensor, such as a scanning planar LiDAR or depth camera, configured to measure depth of a visual scene, as described in FIG. 2 above. Steps of method 700 are effectuated by controller 118 executing computer readable instructions from memory 120.

Block 702 includes the controller 118 receiving a depth measurement or depth image from the LiDAR sensor 202, which includes a plurality of points 204.

Block 704 includes the controller 118 removing points 204, which are greater than a threshold distance from the robot 102. Points 204 may localize objects; however, if the points 204 are substantially far from the robot 102, the objects pose no risk of collision and may be ignored when determining floor space surrounding the robot 102. Further, noise of distance measurements increases as the distance measurements increase. In some embodiments, the sensor 202 may include a field of view that includes a portion of the robot 102 body. The points 204 which localize the robot 102 itself may also be ignored (i.e., removed).

Block 706 includes the controller 118 projecting points 204 below a threshold height onto a 2D height map 502. The height threshold may correspond to a height equal to or greater than the height of the robot 102 since the robot 102 may not be concerned with objects above itself. The height map 502 includes a plurality of pixels 406, each encoded with a height value 408. The height value 408 of the pixel 406 may correspond to the average height of the points 204 projected thereon. More specifically, each pixel 406 of the height map may be representative of a square area of an environment, wherein the average height (i.e., z component) of points 204 localized over each square area corresponds to the height value 408 of the pixel 406.

For example, points 204 may be localized in a voxel coordinate space, as shown in FIG. 4B. The voxel coordinate space may include a plurality of voxels 402 which remain in fixed locations, relative to the stationary environment (i.e., relative to origin 220), and each occupy a fixed volume. Each point 204 may lie within a voxel 402. If a voxel 402 includes a point 204 therein, the voxel 402 may be considered as “occupied”. Voxels 402 without a point 204 may be “unoccupied”. To generate the height map 502, the controller 118 may, for every column of voxels, calculate height values 408 by either (i) calculating the average z height for all points 204 within the column of voxels, or (ii) calculating the average z height for all occupied voxels within the column of voxels.

Block 708 includes the controller 118 calculating a surface normal unit vector 602 for each pixel 406 of the height map 502. The steps executed by the controller 118 to calculate the surface normal unit vector 602 are illustrated above in FIG. 5-6.

Block 710 includes the controller 118 determining pixels 406, which correspond to floor based on their respective surface normal unit vectors 602 being within an angular threshold 604 deviation from a reference surface normal 606. The reference surface normal 606 may include a unit vector \hat{z} with no x or y components. The angular threshold 604 may include an angular range centered about the reference surface normal vector 606 (i.e., \hat{z}). The angular range may include, for example, 1°, 5°, 10°, or 15° deviation from the ideal \hat{z} vector 606 (i.e., the cone 604 shown in FIG. 6(i) may include a 1°, 5°, 10°, or 15° opening angle).

Block 712 includes the controller 118 producing a floor mask based on the pixels 406 identified as floor pixels. The floor mask may include a plurality of pixels 406 of the 2D height map 502 encoded with a “floor” value or denotation. Once the appropriate pixels 406 are encoded with “floor” or “not floor” encodings based on method 700, the height map 502 may be utilized as a floor map. The floor map may include a plurality of pixels, each of the pixels may or may not represent floor within the 2D plane. Such floor map is shown by map 802 in FIG. 8A below.

In some instances, controller 118 may utilize the same data from the at least one sensor 202 and/or other sensors to generate a computer readable map of its surrounding environment, such as an occupancy map or cost map. The occupancy map may include a plurality of pixels and may be based on a 3D to 2D projection of a plurality of points 204 onto a plane, wherein each pixel may be denoted as “occupied” or “unoccupied” based on a point 204, which localizes an object, being projected thereon. That is, the occupancy map includes pixels, which are denoted “object”, “not object”, or similar nomenclature, wherein the robot 102 must navigate without colliding with the object. Pixels comprising points 204 within a certain height range about z=0 plane (i.e., approximate floor points 204) are considered “not objects”. In some instances, however, distance measurements from sensors 202 may be noisy (e.g., reflective floors beneath bright overhead lights or measurements near the maximum range of the sensor) and cause points 204, which, in reality, localize a floor with sufficient noise to be above the threshold height (e.g., greater than 5 cm height), thereby causing the controller 118 to assign noise in a depth image as nearby objects when no objects are nearby. To solve this deficiency, the occupancy map may then be merged with the floor mask produced based on the height map (i.e., the mask denoting which pixels 406 are floor) to determine where nearby objects are and where available floor space is with respect to the robot 102 location. Accordingly, controller 118 of the robot 102 may utilize the known floor space and occupancy map to plan its motions.

By way of illustration, FIG. 8A illustrates a height map 502 comprising a plurality of pixels 406 encoded with “floor” (grey) or “not floor” (white) encodings being merged with a cost map or occupancy map 802 to detect navigable floor surrounding a robot 102, according to an exemplary embodiment. Height map 502 may depict only a portion 806 of the environment shown on map 802 for illustrative clarity, wherein one skilled in the art may appreciate that height map 502 may extend to include all pixels/regions of map 802. Grey pixels 406 of height map 502 represent pixels determined to represent floor space using method 700 discussed above, wherein the surface normal unit vectors 602 were determined to lie within angular threshold 604. White pixels 406 are pixels determined to not represent floor space using method 700 discussed above, wherein the surface normal unit vectors 602 were determined to exceed angular threshold 604.

Map 802 may comprise a cost map or occupancy map, which includes a plurality of pixels with each pixel representing an environmental object 804, navigable floor space 808, and the robot 102. Depth camera 202 is also illustrated in its approximate position; however, it is appreciated that the depth camera 202 may not appear on computer readable maps produced by controller 118 and is used for visual clarity. Cost maps may further include an associated cost for each pixel, the cost corresponding to a cost for the robot 102 to navigate over the pixels, wherein the robot 102 may navigate by executing maneuvers of minimum cost. For example, navigating over pixels representing object 804 may include a high cost while navigating over floor 808 and/or following a route closely may include a low cost. Occupancy maps are similar to cost maps; however, each pixel of occupancy maps does not include an associated cost and may instead simply denote the presence or lack thereof of any object or feature, such as the presence or lack thereof of an object 804 and/or floor space 808.

The pixels 406 of the height map 502 determined to comprise floor (grey) may be utilized by the controller 118 to determine pixels in the map 802 that represent floor 808. For example, in portion 806 of the map 802, the illustrated portion of height map 502 may be utilized to determine pixels representing floor 808 and pixels that represent the wall 804. Controller 118 may perform similar height map calculations to detect floor for the remaining portions of the map 802 outside of portion 806. Accordingly, the controller 118 may produce the map 802 as shown, which includes the object 804, floor space 808, and the robot 102. The floor pixels 808 shown may include detected floor space while the robot 102 is at the illustrated location, wherein the floor pixels 808 shown may represent the field of view of the depth camera 202. The computer readable map 802, including detected floor space pixels 808, may correspond to the floor map described in block 712 of FIG. 7 above.

According to at least one non-limiting exemplary embodiment, floor space detected in the past while the robot 102 is at other locations may be aggregated into map 802 over time. By detecting floor at various locations in the environment, controller 118 may aggregate the detected floor at each location to produce a computer readable map 802 for the entire environment, which includes all of the detected floor at each location of the robot 102.

In some instances, where sensor 202 is a depth camera, controller 118 may trace backwards to determine which pixels 304 of image plane 302 points 204 of the original point cloud (e.g., as shown in FIG. 4B) correspond to and generate an image mask for depth imagery. By way of illustration, FIG. 8B shows a row of pixels 406 of a height map 502, each pixel 406 of the row may be encoded with “floor” (grey) or “not floor” (white) based on method 700 discussed above, according to an exemplary embodiment. All points 204 above the pixels 406 determined to represent floor may be denoted as “floor points” 810 (grey circles) and the remaining points 204 (white) are non-floor points. These floor points 810 correspond to the points 204 projected onto the 2D plane to produce the height map 502, as shown in FIG. 4B above. Next, in FIG. 8C, the floor points 810 are traced back to pixels 304 of the image plane 304 of the depth camera 202 to determine pixels 304 which depict floor, according to an exemplary embodiment. As discussed above in FIG. 3, each point 204 localized by a depth camera 202 may correspond to a distance measurement of a pixel 304 of the image plane 302, as shown by beam 208 (and 208-1, 208-2 in FIG. 3). These pixels 304 may also comprise color values such that depth imagery is produced. Depth imagery or depth images comprise a plurality of pixels, each comprising a color value (e.g., RGB or greyscale) and a distance measurement.

As shown in FIG. 8C, each floor point 810 may be traced back to a pixel 304 of the image plane 302 such that the pixel 304 may be determined to depict floor space. The pixel 812 (grey) may be determined to depict floor because the floor point 810 corresponds to the pixel 812. Controller 118 may, for every floor point 810, determine which pixel 304 of the image plane 302 the floor points 810 correspond to and accordingly mark the pixels 304 as floor pixel 812. The image mask may include a plurality of floor pixels 812 and may be utilized to determine, within the depth image, which pixels represent floor space surrounding the robot 102. Similarly, points 204 in FIG. 8B that represent not-floor-for example, points 204 representing a wall (group 414 in FIG. 4B)— can be mapped into the image plane 302 and corresponding pixels designated as not-floor.

FIG. 8D illustrates an image mask 816 of a depth image 814 captured by a depth camera 202 of a robot 102, according to an exemplary embodiment. The depth image 814 may be produced by the depth camera 202 shown in FIG. 4A while the robot 102 is nearby wall 400. Controller 118 may determine pixels 812, which depict floor within the depth image 814 following the methods shown in FIGS. 7 and 8A-C above. That is, controller 118 may capture a depth image from the depth camera 202, produce a height map 502, calculate surface normal unit vectors 602 for each pixel 406 of the height map 502, determine which pixels 406 represent floor based on an angular threshold 606 applied to each surface normal unit vector 602, determine which points 810 correspond to floor pixels of the height map 502, and correlate those points 810 to pixels 302 of the image plane 302 of the depth camera 202. As shown in the exemplary depth image 814, the pixels 816 correspond to the floor mask (i.e., pixels 812). Pixels 815 corresponding to the wall 400 (points 204 of group 414 in FIG. 4B) are shown as hatched. The portion of the robot 102 body (points 204 of group 410 in FIG. 4B) are depicted as black and the remaining pixels (white) depict a background environment. Although shown in white, the background pixels may include color values that depict the environment, and, in some instances, the background pixels may include distance values if objects are present.

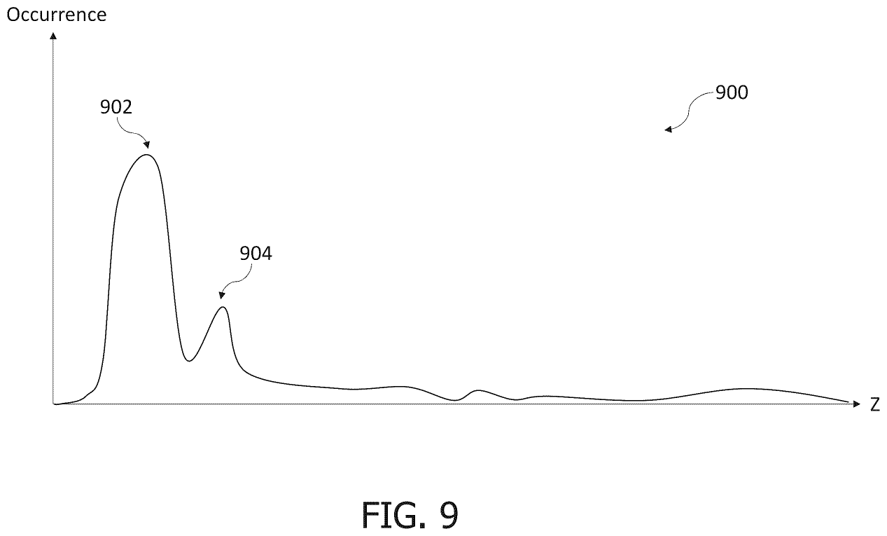

In some scenarios, a robot 102 may be navigating upon a flat floor and sense, using a sensor 202, the flat floor and another flat surface approximately at the same height of the floor. Such flat surface may comprise, for example, a flat table top, a low level empty shelf, a lowered/raised floor (e.g., below/above a set of stairs), and/or other scenarios. In such case, the height map(s) 502 produced may indicate two regions with substantially flat surfaces and may struggle to determine which corresponds to floor. FIG. 9 is a histogram 900 comprising of height values along the horizontal axis and an occurrence of such height values along the vertical axis, according to an exemplary embodiment. The values of the histogram may correspond to height values of one or more height maps 502. Generally, if a robot 102 is operating in an open space free of any objects, a vast majority of the points 204 may cluster around a peak corresponding to the floor. Upon introducing objects to the environment, the points 204 may form one primary peak 902 in addition to populating other height values of the histogram 900. If the robot 102 also encounters a flat surface approximately at the level of the floor, a secondary peak 904 may be observed. The magnitude of the secondary peak 904 should be smaller than the magnitude of the primary peak 902 as, generally, floor space may occupy much more of the field of view than any given flat surface near the floor. Accordingly, if the controller 118 determines two or more regions on a height map 502 meet angular threshold 604 for pixels therein, the controller 118 may select the most prominent or most frequently occurring height (i.e., the height corresponding to the primary peak 902) as corresponding to the floor.

Advantageously, use of a histogram 900 may, in addition to differentiating between flat objects and floor, yield a perceived height of the floor. “Perceived height” refers to the height of the floor given the calibration metrics of the sensor 202 (i.e., the offset between presuming floor is at z=0, or other constant, and the actual measured height as seen by the sensor 202).

Although histogram 900 is shown as a continuous curve, in some embodiments, the histogram 900 may comprise of discrete values.

It will be recognized that, while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various exemplary embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

While the disclosure has been illustrated and described in detail in the drawings and foregoing description, such illustration and description are to be considered illustrative or exemplary and not restrictive. The disclosure is not limited to the disclosed embodiments. Variations to the disclosed embodiments and/or implementations may be understood and effected by those skilled in the art in practicing the claimed disclosure, from a study of the drawings, the disclosure, and the appended claims.

It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “comprising” as used herein is synonymous with “including,” “containing,” or “characterized by,” and is inclusive or open-ended and does not exclude additional, unrecited elements or method steps; the term “having” should be interpreted as “having at least;” the term “such as” should be interpreted as “such as, without limitation;” the term ‘includes” should be interpreted as “includes but is not limited to;” the term “example” or the abbreviation “e.g.” is used to provide exemplary instances of the item in discussion, not an exhaustive or limiting list thereof, and should be interpreted as “example, but without limitation;” the term “illustration” is used to provide illustrative instances of the item in discussion, not an exhaustive or limiting list thereof, and should be interpreted as “illustration, but without limitation.” Adjectives such as “known,” “normal,” “standard,” and terms of similar meaning should not be construed as limiting the item described to a given time period or to an item available as of a given time, but instead should be read to encompass known, normal, or standard technologies that may be available or known now or at any time in the future; and use of terms like “preferably,” “preferred,” “desired,” or “desirable,” and words of similar meaning should not be understood as implying that certain features are critical, essential, or even important to the structure or function of the present disclosure, but instead as merely intended to highlight alternative or additional features that may or may not be utilized in a particular embodiment. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. The terms “about” or “approximate” and the like are synonymous and are used to indicate that the value modified by the term has an understood range associated with it, where the range may be ±20%, ±15%, ±10%, ±5%, or ±1%. The term “substantially” is used to indicate that a result (e.g., measurement value) is close to a targeted value, where close may mean, for example, the result is within 80% of the value, within 90% of the value, within 95% of the value, or within 99% of the value. Also, as used herein “defined” or “determined” may include “predefined” or “predetermined” and/or otherwise determined values, conditions, thresholds, measurements, and the like.

What is claimed is:

1. A robotic system, comprising:
at least one sensor configured to generate a plurality of points corresponding to distance measurements;
a memory comprising plurality of computer readable instructions stored thereon; and
at least one controller configured to execute the plurality of computer readable instructions to:
receive a set of points from a scan by the at least one sensor;
project the set of points onto a two-dimensional height map, the height map comprises a plurality of pixels, each pixel being encoded with a height value based on height values of the set of points projected thereon;
calculate a surface normal unit vector for the each pixel of the height map based on the height values; and
determine one or more pixels of the height map corresponding to a floor space based on a respective surface normal unit vector being within a threshold deviation from a reference surface normal unit vector.

2. The robotic system of claim 1, wherein the at least one controller is further configured to execute the plurality of computer readable instructions to:
determine a first component of the respective surface normal unit vector for the each pixel of the height map based on height value differences between a first pixel and a second pixel, the second pixel being adjacent to the first pixel along a first axis;
determine a second component of the respective surface normal unit vector based on height value differences between the first pixel and a third pixel, the third pixel being adjacent to the first pixel along a second axis orthogonal to the first axis; and
calculate the respective surface normal unit vector based on the cross product of the first and second components.

3. The robotic system of claim 2, wherein the at least one controller is further configured to execute the plurality of computer readable instructions to:
determine a third component of the respective surface normal unit vector for each pixel of the height map based on height value differences between the first pixel and a fourth pixel, the fourth pixel being along the first axis and different from the second pixel;
determine a fourth component of the respective surface normal unit vector based on height value differences between the first pixel and a fifth pixel, the fifth pixel being along the second axis orthogonal to the first axis; and
calculate the respective surface normal unit vector based on an average of the cross product of the first and second components and the third and fourth components.

4. The robotic system of claim 1, wherein the controller is further configured to execute the plurality of computer readable instructions to,
produce the height map based on a subset of points from the set of points of the scan which are within a threshold distance from the robot.

5. The robotic system of claim 1, wherein the controller is further configured to execute the plurality of computer readable instructions to,
produce the height map based on a subset of points from the set of points which are within a threshold height above the robot or floor.

6. The robotic system of claim 1, wherein the at least one controller to is further configured to execute the plurality of computer readable instructions to:
produce a floor mask, the floor mask comprises a plurality of pixels identified as corresponding to floor, the pixels being pixels of at least one of: (i) a computer readable map, the computer readable map comprises objects localized thereon; or (ii) pixels of a depth image captured by the at least sensor.

7. A non-transitory computer readable storage medium comprising a plurality of computer readable instructions stored thereon which, when executed by at least one controller, configure the at least one controller to:
receive a set of points from a scan by the at least one sensor;
project the set of points onto a two-dimensional height map, the height map comprises a plurality of pixels, each pixel being encoded with a height value based on height values of the points projected thereon;
calculate a surface normal unit vector for the each pixel of the height map based on the height values; and
determine one or more pixels of the height map corresponding to a floor space based on a respective surface normal unit vector being within a threshold deviation from a reference surface normal unit vector.

8. The non-transitory computer readable storage medium of claim 7, wherein the controller is further configured to execute the plurality of computer readable instructions to,
calculate the surface normal unit vector for each pixel by:
determine a first component of the respective surface normal unit vector for the each pixel of the height map based on height value differences between a first pixel and a second pixel, the second pixel being adjacent to the first pixel along a first axis;
determine a second component of the respective surface normal unit vector based on height value differences between the first pixel and a third pixel, the third pixel being adjacent to the first pixel along a second axis orthogonal to the first axis; and
calculate the respective surface normal unit vector based on the cross product of the first and second components.

9. The non-transitory computer readable storage medium of claim 8, wherein the controller is further configured to execute the plurality of computer readable instructions to,
determine a third component of the respective surface normal unit vector for each pixel of the height map based on height value differences between the first pixel and a fourth pixel, the fourth pixel being along the first axis and different from the second pixel;
determine a fourth component of the respective surface normal unit vector based on height value differences between the first pixel and a fifth pixel, the fifth pixel being along the second axis orthogonal to the first axis; and
calculate the respective surface normal unit vector based on an average of the cross product of the first and second components and the third and fourth components.

10. The non-transitory computer readable storage medium of claim 7, wherein the controller is further configured to execute the plurality of computer readable instructions to,
produce the height map based on a subset of points from the set of points of the scan which are within a threshold distance from the robot.

11. The non-transitory computer readable storage medium of claim 7, wherein,
the controller is further configured to execute the plurality of computer readable instructions to,
produce the height map based on a subset of points from the set of points which are within a threshold height above the robot or floor.

12. The non-transitory computer readable storage medium of claim 7, further comprising computer readable instructions which, when executed, cause the at least one controller to:
produce a floor mask, the floor mask comprises a plurality of pixels identified as corresponding to floor, the pixels being pixels of at least one of (i) a computer readable map, the computer readable map comprises objects localized thereon; or (ii) pixels of a depth image captured by the at least sensor.

13. A method, comprising:
receiving a set of points from a scan by at least one sensor;
projecting the set of points onto a two-dimensional height map, the height map comprises a plurality of pixels, each pixel being encoded with a height value based on height values of the points projected thereon;
calculating a surface normal unit vector for the each pixel of the height map based on the height values; and
determining one or more pixels of the height map correspond to floor space based on the respective surface normal unit vector being within a threshold deviation from an reference surface normal unit vector.

14. The method of claim 13, further comprising:
calculating the surface normal unit vector for each pixel by:
determining a first component of the respective surface normal unit vector for each pixel of the height map based on height value differences between a first pixel and a second pixel, the second pixel being adjacent to the first pixel along a first axis;
determining a second component of the respective surface normal unit vector based on height value differences between the first pixel and a third pixel, the third pixel being adjacent to the first pixel along a second axis orthogonal to the first axis; and
calculating the respective surface normal unit vector based on the cross product of the first and second components.

15. The method of claim 14, further comprising:
determining a third component of the respective surface normal unit vector for the pixels of the height map based on height value differences between the first pixel and a fourth pixel, the fourth pixel being along the first axis and different from the second pixel;
determining a fourth component of the respective surface normal unit vector based on height value differences between the first pixel and a fifth pixel, the fifth pixel being along the second axis orthogonal to the first axis; and
calculating the respective surface normal unit vector based on an average of the cross product of the first and second components and the third and fourth components.

16. The method of claim 13, further comprising:
producing the height map based on a subset of points from the set of points of the scan which are within a threshold distance from the robot.

17. The method of claim 13, wherein,
producing the height map based on a subset of points from the set of points which are within a threshold height above the robot or floor.

18. The method of claim 13, further comprising the at least one controller:
producing a floor mask, the floor mask comprises a plurality of pixels identified as corresponding to floor, the pixels being pixels of at least one of (i) a computer readable map, the computer readable map comprises objects localized thereon; or (ii) pixels of a depth image captured by the at least sensor.

19. A robotic system, comprising:
at least one sensor configured to generate a plurality points corresponding to distance measurements;
a non-transitory computer readable storage medium comprising a plurality of computer readable instructions stored thereon; and
at least one controller configured to execute the plurality of computer readable instructions to:
receive a set of points from a scan by the at least one sensor, the sensor includes a field of view, the field of view encompasses at least a floor and a flat object;
produce a height map based on the set of points, the height map comprises a plurality of pixels each comprising a respective height value;
detect pixels of the height map which correspond to floor based upon pixels of the height map comprising (i) a flat topology less than a threshold deviation, and (ii) most frequent height values of the pixels of the height map.
